(19) United States
(12) Patent Application Publication
(10) Pub. No.: US 2026/0360020 A1
(43) Pub. Date: Nov. 12, 2026

(54) METHOD AND APPARATUS FOR OPTIMISED SIGNALLING FOR IMAGE ENHANCEMENT FILTER SELECTION

(71) Applicant: HUAWEI TECHNOLOGIES CO., LTD., Shenzhen (CN)

(72) Inventors: Ahmet Burakhan Koyuncu, Munich (DE); Atanas Boev, Munich (DE); Aleyna Kara, Munich (DE); Elena Alexandrovna Alshina, Munich (DE)

(73) Assignee: HUAWEI TECHNOLOGIES CO., LTD., Shenzhen (CN)

(21) Appl. No.: 19/746,051

(22) Filed: Jul. 17, 2026

Related U.S. Application Data
(63) Continuation of application No. PCT/EP2024/080641, filed on Oct. 30, 2024.

(30) Foreign Application Priority Data
Jan. 17, 2024 (WO) PCT/EP2024/051023

(51) Int. Cl. G06T 9/00; H04N 19/117

(52) U.S. Cl. CPC G06T 9/002; H04N 19/117

(57) ABSTRACT

A decoding method for a codec includes receiving a bitstream comprising an image to be decoded, determining one or more neural network-based encoder model parameters based on a codec index which identifies the codec, determining a plurality of filter lists including a short list and a long list of luma filters and a short list and a long list of chroma filters. The method further includes receiving a plurality of signals comprising: filter index information comprising a luma filter index and a chroma filter index, filter list information comprising an indication of a length of a luma filter list to be used and an indication of a length of a chroma filter list to be used, and filter selection information for determining a luma filter and a chroma filter to be used to decode the image.

### CROSS-REFERENCE TO RELATED APPLICATIONS

This application is a continuation of International Application No. PCT/EP2024/080641, filed on Oct. 30, 2024, which claims priority to International Patent Application No. PCT/EP2024/051023, filed on Jan. 17, 2024. The disclosures of the aforementioned applications are hereby incorporated by reference in their entireties.

### TECHNICAL FIELD

Embodiments of the present disclosure generally relate to the field of encoding and decoding images and/or videos databased on a neural network architecture. In particular, some embodiments relate to methods and apparatuses for such encoding and decoding images and/or videos from a bitstream using a plurality of processing layers.

### BACKGROUND

Hybrid image and video codecs have been used for decades to compress image and video data. In such codecs, signal is typically encoded block-wisely by predicting a block7 and by further coding only the difference between the original bock and its prediction. In particular, such coding may include transformation, quantization and generating the bitstream, usually including some entropy coding. Typically, the three components of hybrid coding methods-transformation, quantization, and entropy coding—are separately optimized. Modern video compression standards like High-Efficiency Video Coding (HEVC), Versatile Video Coding (VVC) and Essential Video Coding (EVC) also use transformed representation to code residual signal after prediction.

Recently, neural network architectures have been applied to image and/or video coding. In general, these neural network (NN) based approaches can be applied in various different ways to the image and video coding. For example, some end-to-end optimized image or video coding frameworks have been discussed. Moreover, deep learning has been used to determine or optimize some parts of the end-to-end coding framework such as selection or compression of prediction parameters or the like. Besides, some neural network based approached have also been discussed for usage in hybrid image and video coding frameworks, e.g. for implementation as a trained deep learning model for intra or inter prediction in image or video coding.

The end-to-end optimized image or video coding applications discussed above have in common that they produce some feature map data, which is to be conveyed between encoder and decoder according to this disclosure.

Neural networks are machine learning models that employ one or more layers of nonlinear units based on which they can predict an output for a received input. Some neural networks include one or more hidden layers in addition to an output layer. A corresponding feature map may be provided as an output of each hidden layer. Such corresponding feature map of each hidden layer may be used as an input to a subsequent layer in the network, i.e., a subsequent hidden layer or the output layer. Each layer of the network generates an output from a received input in accordance with current values of a respective set of parameters. In a neural network that is split between devices, e.g. between encoder and decoder, a device and a cloud or between different devices, a feature map at the output of the place of splitting (e.g. a first device) is compressed and transmitted to the remaining layers of the neural network (e.g. to a second device).

Further improvement of encoding and decoding using trained network architectures may be desirable.

### SUMMARY

The present disclosure provides methods and apparatuses to improve the selection of one or more image filters for post-processing of the output of an AI-based image codec.

According to a first aspect, the present disclosure relates to a method for decoding for a codec. The method is performed by an apparatus for decoding. The method includes: receiving a bitstream comprising an image to be decoded; determining one or more neural network based encoder model parameters based on a codec index which identifies the codec; determining a plurality of filter lists comprised of a short list and a long list of luma filters, and a short list and a long list of chroma filters based on the determined one or more neural network based encoder model parameters; receiving a plurality of signals comprising: filter index information comprising a luma filter index and a chroma filter index, filter list information comprising an indication of a length of a luma filter list to be used and an indication of a length of a chroma filter list to be used, and filter selection information for determining a luma filter and a chroma filter to be used to decode the image; the method further comprising: selecting a short list of luma filters or a long list of luma filters, and/or selecting a short list of chroma filters or a long list of chroma filters for processing the image based on the determined one or more neural network based encoder model parameters, the determined filter lists and the received plurality of signals; and processing the image using the selected short list of luma filters or the long list of luma filters, and/or the short list of chroma filters or the long list of chroma filters. This allows for the computational burden to be reduced by not processing all filters when decoding an image to obtain a faithful reconstruction of the encoded image.

The foregoing and other embodiments can each optionally include one or more of the following features, alone or in combination.

In a possible implementation, the method as described above may in that, in selecting the short list of luma filters or the long list of luma filters, and/or in selecting the short list of chroma filters or the long list of chroma filters, the filter list information indicates whether the short list or the long list for the luma are to be selected for use and the short list or the long list for the chroma are to be selected for use. This allows for a reduced message to be provided that allows the selection of the filter lists to be adapted depending on the requirements of the codec.

The method as described above, wherein the short list of luma filters is comprised of two or more luma filters of the luma filter index that are the most frequently applied for the codec; and the short list of chroma filters is comprised of two or more of chroma filters from the chroma filter index that are the most frequently applied for the codec. This allows the most frequently used filters to be separated from the other filters in the filter index information and thus provide a reduced list of filters for processing therefore reducing the computational burden on the decoder.

The method as described above, wherein the short list of luma filters and the short list of chroma filters are each represented by at least 1 bit, and wherein the long list of luma filters and the long list of chroma filters are each represented by at least 3 bits. This allows for the filter list length to be adapted to include all of the filter index information or a subsection of filters that are not included in the shortList thus reducing the need to process the image using all the filters for each codec.

The method as described above, the method further comprising; determining a quality loss for the image in the bitstream compared to the original image; determining a quality loss for the image processed by each luma filter and/or a chroma filter used by the luma filter model and/or a chroma filter model by comparing each luma filter and/or a chroma filter used by the luma filter model and/or a chroma filter model to the original image; and selecting whether to use the image in the bitstream or the image processed by the luma and/or chroma filter based on the determined quality loss of each luma filter and/or a chroma filter used by the luma filter model and/or a chroma filter model selected from the filter selection information and the quality loss for the image in the bitstream compared to the original image.

The method as described above, wherein the filter selection information comprises binary information indicating whether each luma or chroma filter separately and distinctly are activated. This allows for each component of the luma and chroma to be considered separately when outputting the image.

The method as described above, wherein the when one or more of the luma and/or chroma filter are not activated, then the filter used for processing the image is the luma and/or chroma filter from the received filter index information. This allows for each of the colour components to be individually controlled when applying a filter to them.

The method as described above, wherein when the long list of luma filters and the long list of chroma filters are each represented by at least 3 bits, the long list of luma filters comprises the filters from the luma filter index that are not comprised in the short list, and the long list of chroma filters comprises the filters from the chroma filter index that are not comprised in the short list; and when the long list of luma filters and the long list of chroma filters are each represented by at least 4 bits, the long list of luma filters comprises all of the filters from the luma filter index, and the long list of chroma filters comprises all of the filters from the chroma filter index. This allows for the filter list length to be adapted to include all of the filter index information or a subsection of filters that are not included in the shortList thus allowing for all filter combinations to be achieved or only a subset of the filter combinations depending on system requirements.

The method as described above, wherein if the filter list information indicates that the length of the luma filter list to be used is short then the short list of luma filters is indicated as true, and the length of the chroma filter list to be used is also short then the short list of chroma filters is indicated as true. This allows for reduced complexity signalling by forcing the list length for each colour component to be the same such that processing is not unnecessarily increased.

The method as described above, wherein when the filter selection information for determining a luma filter and a chroma filter to be used to decode the image indicates that both the luma filter and the chroma filter are false, then no filter is applied to the image in the bitstream. This allows for no filter processing to be performed when some or all of the colour components are deactivated thus reducing the computational workload.

According to a second aspect, the present disclosure relates to a method for encoding which produces the explicit signals for the apparatus for decoding. The method is performed by an apparatus for encoding. The method includes: generating a plurality of signals comprising: filter index information comprising a luma filter index and a chroma filter index, filter list information comprising an indication of a length of a luma filter list to be used and an indication of a length of a chroma filter list to be used, and filter selection information for determining a luma filter and a chroma filter to be used to decode the image.

The foregoing and other embodiments can each optionally include one or more of the following features, alone or in combination.

According to a further aspect of this disclosure there is provided an apparatus for decoding comprising one or more processing units, the one or more processing units configured to: receive a bitstream comprising an image to be decoded; determine one or more neural network based encoder model parameters based on a codec index which identifies the codec; determine a plurality of filter lists comprised of a short list and a long list of luma filters, and a short list and a long list of chroma filters based on the determined one or more neural network based encoder model parameters; receive a plurality of signals comprising: filter index information comprising a luma filter index and a chroma filter index, filter list information comprising an indication of a length of a luma filter list to be used and an indication of a length of a chroma filter list to be used, and filter selection information for determining a luma filter and a chroma filter to be used to decode the image; the one or more processors further configured to: select a short list of luma filters or a long list of luma filters, and/or selecting a short list of chroma filters or a long list of chroma filters for processing the image based on the determined one or more neural network based encoder model parameters, the determined filter lists and the received plurality of signals; and process the image using the selected short list of luma filters or the long list of luma filters, and/or the short list of chroma filters or the long list of chroma filters. Such apparatus for decoding may refer to the same advantageous effect as the method for decoding according to the first aspect. Details are not described herein again. The decoding apparatus provides technical means for implementing an action in the method defined according to the first aspect. The function may be implemented by hardware, or may be implemented by hardware executing corresponding software. The apparatus for decoding according to this disclosure may comprise one or more modules that may include the one or more processors. These modules may be adapted to provide respective functions which correspond to the method example according to the first aspect. For details, it is referred to the detailed descriptions in the method example. Details are not described herein again.

The apparatus as described above, wherein in selecting the short list of luma filters or the long list of luma filters, and/or in selecting the short list of chroma filters or the long list of chroma filters, the filter list information indicates whether the short list or the long list for the luma are to be selected for use and the short list or the long list for the chroma are to be selected for use.

The apparatus as described above, wherein the short list of luma filters is comprised of two or more luma filters of the luma filter index that are the most frequently applied for the codec; and the short list of chroma filters is comprised of two or more of chroma filters from the chroma filter index that are the most frequently applied for the codec.

The apparatus as described above, wherein the short list of luma filters and the short list of chroma filters are each represented by at least 1 bit, and wherein the long list of luma filters and the long list of chroma filters are each represented by at least 3 bits.

The apparatus as described above, the one or more processing units further configured to: select whether to use the processed image or the image in the bitstream prior to processing based on the filter selection information.

The apparatus as described above, wherein the filter selection information comprises binary information indicating whether each luma or chroma filter separately and distinctly are activated.

The apparatus as described above, wherein the when one or more of the luma and/or chroma filter are not activated, then the filter used for processing the image is the luma and/or chroma filter from the received filter index information.

The apparatus as described above, wherein when the long list of luma filters and the long list of chroma filters are each represented by 3 bits, the long list of luma filters comprises the filters from the luma filter index that are not comprised in the short list, and the long list of chroma filters comprises the filters from the chroma filter index that are not comprised in the short list; and when the long list of luma filters and the long list of chroma filters are each represented by 4 bits, the long list of luma filters comprises all of the filters from the luma filter index, and the long list of chroma filters comprises all of the filters from the chroma filter index.

The apparatus as described above, wherein if the filter list information indicates that the length of the luma filter list to be used is short then the short list of luma filters is indicated as true, and the length of the chroma filter list to be used is also short then the short list of chroma filters is indicated as true.

The apparatus as described above, wherein when the filter selection information for determining a luma filter and a chroma filter to be used to decode the image indicates that both the luma filter and the chroma filter are false, then no filter is applied to the image in the bitstream.

According to a fourth aspect, the present disclosure relates to an apparatus for encoding. Such apparatus for encoding may refer to the same advantageous effect as the method for encoding according to the second aspect. Details are not described herein again. The encoding apparatus provides technical means for implementing an action in the method defined according to the second aspect. The function may be implemented by hardware, or may be implemented by hardware executing corresponding software. In a possible implementation, the encoding apparatus may include one or more modules comprised of one or more processor configured to generate the signals described above. These modules may be adapted to provide respective functions which correspond to the method example according to the second aspect. For details, it is referred to the detailed descriptions in the method example. Details are not described herein again.

The method according to the first aspect of the present disclosure may be performed by the apparatus according to the third aspect of the present disclosure. Further features and implementations of the method according to the first aspect of the present disclosure correspond to respective features and implementations of the apparatus according to the third aspect of the present disclosure. The advantages of the method according to the first aspect can be the same as those for the corresponding implementation of the apparatus according to the third aspect.

The method according to the second aspect of the present disclosure may be performed by the apparatus according to the fourth aspect of the present disclosure. Further features and implementations of the method according to the second aspect of the present disclosure correspond to respective features and implementations of the apparatus according to the fourth aspect of the present disclosure. The advantages of the method according to the second aspect can be the same as those for the corresponding implementation of the apparatus according to the fourth aspect.

According to a fifth aspect, the present disclosure relates to a video stream decoding apparatus, including a processor and a memory. The memory stores instructions that cause the processor to perform the method according to the first aspect.

According to a sixth aspect, the present disclosure relates to a video stream encoding apparatus, including a processor and a memory. The memory stores instructions that cause the processor to perform the method according to the second aspect.

According to a seventh aspect, a computer-readable storage medium having stored thereon instructions that when executed cause one or more processors to encode video data is proposed. The instructions cause the one or more processors to perform the method according to the first or second aspect or any possible embodiment of the first or second aspect.

According to an eighth aspect, the present disclosure relates to a computer program product including program code for performing the method according to the first or second aspect or any possible embodiment of the first or second aspect when executed on a computer.

Details of one or more embodiments are set forth in the accompanying drawings and the description below. Other features, objects, and advantages will be apparent from the description, drawings, and claims.

### BRIEF DESCRIPTION OF THE DRAWINGS

In the following embodiments of the present disclosure are described in more detail with reference to the attached figures and drawings, in which

FIG. 1 is a schematic drawing illustrating channels processed by layers of a neural network;

FIG. 2 is a schematic drawing illustrating an autoencoder type of a neural network;

FIG. 3A is a schematic drawing illustrating an exemplary network architecture for encoder and decoder side including a hyperprior model;

FIG. 3B is a schematic drawing illustrating a general network architecture for encoder side including a hyperprior model;

FIG. 3C is a schematic drawing illustrating a general network architecture for decoder side including a hyperprior model;

FIG. 4 is a schematic drawing illustrating an exemplary network architecture for encoder and decoder side including a hyperprior model;

FIG. 5 is a block diagram illustrating a structure of a cloud-based solution for machine based tasks such as machine vision tasks;

FIG. 6A-C are block diagrams illustrating aspects of an end-to-end video compression framework based on a neural network;

FIG. 7 shows an example of the contents of ŷ and how the image is comprised in the bitstream;

FIG. 8 shows an example of a general post-processing filter according to the present disclosure;

FIG. 9 shows an example of an implementation of an ICCI-DWT filter selection in an encoder;

FIG. 10 shows an example of a decoder that implements an ICCI-DWT filter selection;

FIG. 11 shows an example of the adapted decoder according to the present disclosure;

FIG. 12 shows an example of the detailed structure of the signalling according to this disclosure;

FIG. 13 shows an example of the algorithm for reading the filter selection messages;

FIG. 14 is a schematic drawing illustrating scaling a coding network;

FIG. 15 exemplary show VAE-based codecs using the YUV colour space as an input of an encoder and an output of a decoder;

FIG. 16 is a block diagram showing an example of a video coding system conFigured to implement embodiments of the present disclosure;

FIG. 17 is a block diagram showing another example of a video coding system conFigured to implement embodiments of the present disclosure;

FIG. 18 is a block diagram illustrating an example of an encoding apparatus or a decoding apparatus;

FIG. 19 is a block diagram illustrating another example of an encoding apparatus or a decoding apparatus;

FIG. 20 is a block diagram illustrating another example of an encoding apparatus or a decoding apparatus.

Like reference numbers and designations in different drawings may indicate similar elements.

### DETAILED DESCRIPTION OF THE EMBODIMENTS

In the following description, reference is made to the accompanying figures, which form part of the disclosure, and which show, by way of illustration, specific aspects of embodiments of the present disclosure or specific aspects in which embodiments of the present disclosure may be used. It is understood that embodiments of the present disclosure may be used in other aspects and comprise structural or logical changes not depicted in the figures. The following detailed description, therefore, is not to be taken in a limiting sense, and the scope of the present disclosure is defined by the appended claims.

For instance, it is understood that a disclosure in connection with a described method may also hold true for a corresponding device or system configured to perform the method and vice versa. For example, if one or a plurality of specific method steps are described, a corresponding device may include one or a plurality of units, e.g. functional units, to perform the described one or plurality of method steps (e.g. one unit performing the one or plurality of steps, or a plurality of units each performing one or more of the plurality of steps), even if such one or more units are not explicitly described or illustrated in the figures. On the other hand, for example, if a specific apparatus is described based on one or a plurality of units, e.g. functional units, a corresponding method may include one step to perform the functionality of the one or plurality of units (e.g. one step performing the functionality of the one or plurality of units, or a plurality of steps each performing the functionality of one or more of the plurality of units), even if such one or plurality of steps are not explicitly described or illustrated in the figures. Further, it is understood that the features of the various exemplary embodiments and/or aspects described herein may be combined with each other, unless specifically noted otherwise.

In the following, an overview over some of the used technical terms and framework within which the embodiments of the present disclosure may be employed is provided.

### Artificial Neural Networks

Artificial neural networks (ANN) or connectionist systems are computing systems vaguely inspired by the biological neural networks that constitute animal brains. Such systems “learn” to perform tasks by considering examples, generally without being programmed with task-specific rules. For example, in image recognition, they might learn to identify images that contain cats by analyzing example images that have been manually labeled as “cat” or “no cat” and using the results to identify cats in other images. They do this without any prior knowledge of cats, for example, that they have fur, tails, whiskers and cat-like faces. Instead, they automatically generate identifying characteristics from the examples that they process.

An ANN is based on a collection of connected units or nodes called artificial neurons, which loosely model the neurons in a biological brain. Each connection, like the synapses in a biological brain, can transmit a signal to other neurons. An artificial neuron that receives a signal then processes it and can signal neurons connected to it.

In ANN implementations, the “signal” at a connection is a real number, and the output of each neuron is computed by some non-linear function of the sum of its inputs. The connections are called edges. Neurons and edges typically have a weight that adjusts as learning proceeds. The weight increases or decreases the strength of the signal at a connection. Neurons may have a threshold such that a signal is sent only if the aggregate signal crosses that threshold. Typically, neurons are aggregated into layers. Different layers may perform different transformations on their inputs. Signals travel from the first layer (the input layer), to the last layer (the output layer), possibly after traversing the layers multiple times.

The original goal of the ANN approach was to solve problems in the same way that a human brain would. Over time, attention moved to performing specific tasks, leading to deviations from biology. ANNs have been used on a variety of tasks, including computer vision, speech recognition, machine translation, social network filtering, playing board and video games, medical diagnosis, and even in activities that have traditionally been considered as reserved to humans, like painting.

The name “convolutional neural network” (CNN) indicates that the network employs a mathematical operation called convolution. Convolution is a specialized kind of linear operation. Convolutional networks are neural networks that use convolution in place of a general matrix multiplication in at least one of their layers.

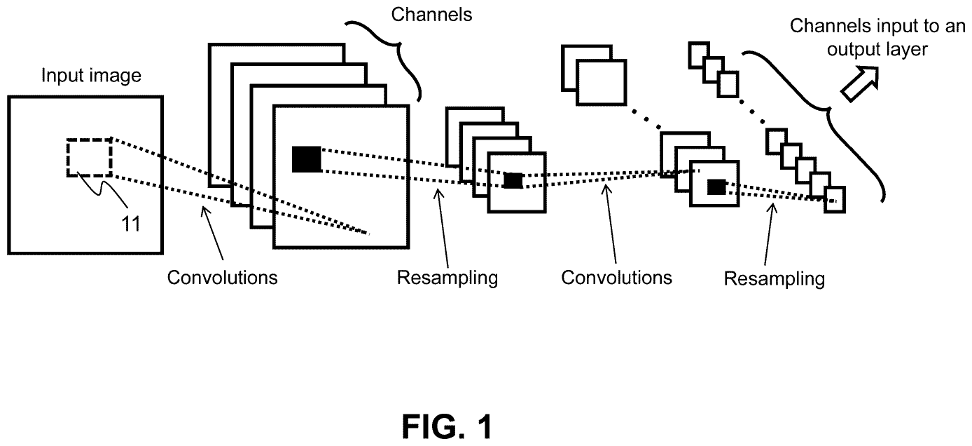

FIG. 1 schematically illustrates a general concept of processing by a neural network such as the CNN. A convolutional neural network consists of an input and an output layer, as well as multiple hidden layers. Input layer is the layer to which the input (such as a portion 11 of an input image as shown in FIG. 1) is provided for processing. The hidden layers of a CNN typically consist of a series of convolutional layers that convolve with a multiplication or other dot product. The result of a layer is one or more feature maps (illustrated by empty solid-line rectangles), sometimes also referred to as channels. There may be a resampling (such as subsampling) involved in some or all of the layers. As a consequence, the feature maps may become smaller, as illustrated in FIG. 1. It is noted that a convolution with a stride may also reduce the size (resample) an input feature map. The activation function in a CNN is usually a ReLU (Rectified Linear Unit) layer or Leaky ReLU, and is subsequently followed by additional convolutions such as pooling layers, fully connected layers and normalization layers, referred to as hidden layers because their inputs and outputs are masked by the activation function and final convolution. Though the layers are colloquially referred to as convolutions, this is only by convention. Mathematically, it is technically a sliding dot product or cross-correlation. This has significance for the indices in the matrix, in that it affects how the weight is determined at a specific index point.

When programming a CNN for processing images, as shown in FIG. 1. the input is a tensor with shape (number of images)×(image width)×(image height)×(image depth). It should be known that the image depth can be constituted by channels of an image. After passing through a convolutional layer, the image becomes abstracted to a feature map, with shape (number of images)×(feature map width)×(feature map height)×(feature map channels). A convolutional layer within a neural network should have the following attributes. Convolutional kernels defined by a width and height (hyper-parameters). The number of input channels and output channels (hyper-parameter). The depth of the convolution filter (the input channels) should be equal to the number channels (depth) of the input feature map.

In the past, traditional multilayer perceptron (MLP) models have been used for image recognition. However, due to the full connectivity between nodes, they suffered from high dimensionality, and did not scale well with higher resolution images. A 1000×1000-pixel image with RGB color channels has 3 million weights, which is too high to feasibly process efficiently at scale with full connectivity. Also, such network architecture does not take into account the spatial structure of data, treating input pixels which are far apart in the same way as pixels that are close together. This ignores locality of reference in image data, both computationally and semantically. Thus, full connectivity of neurons is wasteful for purposes such as image recognition that are dominated by spatially local input patterns.

Convolutional neural networks are biologically inspired variants of multilayer perceptrons that are specifically designed to emulate the behavior of a visual cortex. These models mitigate the challenges posed by the MLP architecture by exploiting the strong spatially local correlation present in natural images. The convolutional layer is the core building block of a CNN. The layer's parameters consist of a set of learnable filters (the above-mentioned kernels), which have a small receptive field, but extend through the full depth of the input volume. During the forward pass, each filter is convolved across the width and height of the input volume, computing the dot product between the entries of the filter and the input and producing a 2-dimensional activation map of that filter. As a result, the network learns filters that activate when it detects some specific type of feature at some spatial position in the input.

Stacking the activation maps for all filters along the depth dimension forms the full output volume of the convolution layer. Every entry in the output volume can thus also be interpreted as an output of a neuron that looks at a small region in the input and shares parameters with neurons in the same activation map. A feature map, or activation map, is the output activations for a given filter. Feature map and activation has same meaning. In some papers it is called an activation map because it is a mapping that corresponds to the activation of different parts of the image, and also a feature map because it is also a mapping of where a certain kind of feature is found in the image. A high activation means that a certain feature was found.

Another important concept of CNNs is pooling, which is a form of non-linear downsampling. There are several non-linear functions to implement pooling among which max pooling is the most common. It partitions the input image into a set of non-overlapping rectangles and, for each such sub-region, outputs the maximum.

Intuitively, the exact location of a feature is less important than its rough location relative to other features. This is the idea behind the use of pooling in convolutional neural networks. The pooling layer serves to progressively reduce the spatial size of the representation, to reduce the number of parameters, memory footprint and amount of computation in the network, and hence to also control overfitting. It is common to periodically insert a pooling layer between successive convolutional layers in a CNN architecture. The pooling operation provides another form of translation invariance.

The pooling layer operates independently on every depth slice of the input and resizes it spatially. The most common form is a pooling layer with filters of size 2×2 applied with a stride of 2 at every depth slice in the input by 2 along both width and height, discarding 75% of the activations. In this case, every max operation is over 4 numbers. The depth dimension remains unchanged. In addition to max pooling, pooling units can use other functions, such as average pooling or l2-norm pooling. Average pooling was often used historically but has recently fallen out of favour compared to max pooling, which often performs better in practice. Due to the aggressive reduction in the size of the representation, there is a recent trend towards using smaller filters or discarding pooling layers altogether. “Region of Interest” pooling (also known as ROI pooling) is a variant of max pooling, in which output size is fixed and input rectangle is a parameter. Pooling is an important component of convolutional neural networks for object detection based on Fast R-CNN architecture.

The above-mentioned ReLU is the abbreviation of rectified linear unit, which applies the non-saturating activation function. It effectively removes negative values from an activation map by setting them to zero. It increases the nonlinear properties of the decision function and of the overall network without affecting the receptive fields of the convolution layer. Other functions are also used to increase nonlinearity, for example the saturating hyperbolic tangent and the sigmoid function. ReLU is often preferred to other functions because it trains the neural network several times faster without a significant penalty to generalization accuracy.

Leaky Rectified Linear Unit, or Leaky ReLU, is a type of activation function based on a ReLU, but it has a small slope for negative values instead of a flat slope. The slope coefficient is determined before training, i.e. it is not learnt during training. This type of activation function is popular in tasks where it suffers from sparse gradients, for example training generative adversarial networks. Leaky ReLU applies the element-wise function:

$$LeakyReLU ( x ) = max ( 0 , x ) + negative\_slope ⋆ min ( 0 , x ) , or$$

$$LeakyReLU ( x ) = max \{ \begin{matrix}x , if x \geq 0 \\ negative\_slope * x , otherwise )\end{matrix}$$

Among them, parameters:
negative_slope—Controls the angle of the negative slope. Default: le-2
inplace—can optionally do the operation in-place. Default: False.

After several convolutional and max pooling layers, the high-level reasoning in the neural network is done via fully connected layers. Neurons in a fully connected layer have connections to all activations in the previous layer, as seen in regular (non-convolutional) artificial neural networks. Their activations can thus be computed as an affine transformation, with matrix multiplication followed by a bias offset (vector addition of a learned or fixed bias term).

The “loss layer” (including calculating of a loss function) specifies how training penalizes the deviation between the predicted (output) and true labels and is normally the final layer of a neural network. Various loss functions appropriate for different tasks may be used. Softmax loss is used for predicting a single class of K mutually exclusive classes. Sigmoid cross-entropy loss is used for predicting K independent probability values in [0, 1]. Euclidean loss is used for regressing to real-valued labels.

In summary, FIG. 1 shows the data flow in a typical convolutional neural network. First, the input image is passed through convolutional layers and becomes abstracted to a feature map comprising several channels, corresponding to a number of filters in a set of learnable filters of this layer. Then, the feature map is subsampled using e.g. a pooling layer, which reduces the dimension of each channel in the feature map. Next, the data comes to another convolutional layer, which may have different numbers of output channels. As was mentioned above, the number of input channels and output channels are hyper-parameters of the layer. To establish connectivity of the network, those parameters need to be synchronized between two connected layers, such that the number of input channels for the current layers should be equal to the number of output channels of the previous layer. For the first layer which processes input data, e.g. an image, the number of input channels is normally equal to the number of channels of data representation, for instance 3 channels for RGB or YUV representation of images or video, or 1 channel for grayscale image or video representation. The channels obtained by one or more convolutional layers (and possibly resampling layer(s)) may be passed to an output layer. Such output layer may be a convolutional or resampling in some implementations. In an exemplary and non-limiting implementation, the output layer is a fully connected layer. Autoencoders and unsupervised learning

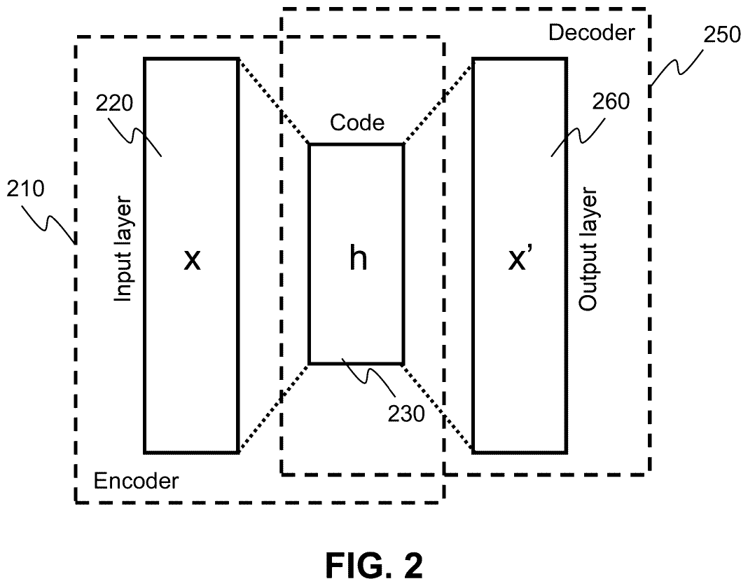

An autoencoder is a type of artificial neural network used to learn efficient data codings in an unsupervised manner. A schematic drawing thereof is shown in FIG. 2. The autoencoder includes an encoder side 210 with an input x inputted into an input layer of an encoder subnetwork 220 and a decoder side 250 with output x′ outputted from a decoder subnetwork 260. The aim of an autoencoder is to learn a representation (encoding) 230 for a set of data x, typically for dimensionality reduction, by training the network 220, 260 to ignore signal “noise”. Along with the reduction (encoder) side subnetwork 220, a reconstructing (decoder) side subnetwork 260 is learnt, where the autoencoder tries to generate from the reduced encoding 230 a representation x′ as close as possible to its original input x, hence its name. In the simplest case, given one hidden layer, the encoder stage of an autoencoder takes the input x and maps it to h

h=σ(Wx+b).

This image h is usually referred to as code 230, latent variables, or latent representation. Here, σ is an element-wise activation function such as a sigmoid function or a rectified linear unit. W is a weight matrix b is a bias vector. Weights and biases are usually initialized randomly, and then updated iteratively during training through Backpropagation. After that, the decoder stage of the autoencoder maps h to the reconstruction x′ of the same shape as x:

x′=σ′(W′h′+b′)
where σ′, W′ and b′ for the decoder may be unrelated to the corresponding σ, W and b for the encoder.

Variational autoencoder models make strong assumptions concerning the distribution of latent variables. They use a variational approach for latent representation learning, which results in an additional loss component and a specific estimator for the training algorithm called the Stochastic Gradient Variational Bayes (SGVB) estimator. It assumes that the data is generated by a directed graphical model p_{θ}(x|h) and that the encoder is learning an approximation q_{φ}(h|x) to the posterior distribution p_{θ}(h|x) where φ and θ denote the parameters of the encoder (recognition model) and decoder (generative model) respectively. The probability distribution of the latent vector of a VAE typically matches that of the training data much closer than a standard autoencoder. The objective of VAE has the following form:

[symbol]

(φ,θ,x)=D_{KL}(q_{φ}(h|x)∥p_{θ}(h))−E_{q}_{_{φ(h|x)}}(log p_{θ}(x|h))

Here, D_{KL} Stands for the Kullback-Leibler divergence. The prior over the latent variables is usually set to be the centered isotropic multivariate Gaussian p_{θ}(h)= [symbol] (0, I). Commonly, the shape of the variational and the likelihood distributions are chosen such that they are factorized Gaussians:

q_{φ}(h|x)= [symbol] (ρ(x),ω²(x)I)

p_{θ}(x|h)= [symbol] (μ(h),σ₂(h)I)

where ρ(x) and ω² (x) are the encoder output, while μ(h) and σ²(h) are the decoder outputs.

Recent progress in artificial neural networks area and especially in convolutional neural networks enables researchers' interest of applying neural networks based technologies to the task of image and video compression. For example, End-to-end Optimized Image Compression has been proposed, which uses a network based on a variational autoencoder.

Accordingly, data compression is considered as a fundamental and well-studied problem in engineering, and is commonly formulated with the goal of designing codes for a given discrete data ensemble with minimal entropy. The solution relies heavily on knowledge of the probabilistic structure of the data, and thus the problem is closely related to probabilistic source modelling. However, since all practical codes must have finite entropy, continuous-valued data (such as vectors of image pixel intensities) must be quantized to a finite set of discrete values, which introduces an error.

In this context, known as the lossy compression problem, one must trade off two competing costs: the entropy of the discretized representation (rate) and the error arising from the quantization (distortion). Different compression applications, such as data storage or transmission over limited-capacity channels, demand different rate-distortion trade-offs.

Joint optimization of rate and distortion is difficult. Without further constraints, the general problem of optimal quantization in high-dimensional spaces is intractable. For this reason, most existing image compression methods operate by linearly transforming the data vector into a suitable continuous-valued representation, quantizing its elements independently, and then encoding the resulting discrete representation using a lossless entropy code. This scheme is called transform coding due to the central role of the transformation.

For example, JPEG uses a discrete cosine transform on blocks of pixels, and JPEG 2000 uses a multi-scale orthogonal wavelet decomposition. Typically, the three components of transform coding methods-transform, quantizer, and entropy code—are separately optimized (often through manual parameter adjustment). Modern video compression standards like HEVC, VVC and EVC also use transformed representation to code residual signal after prediction. The several transforms are used for that purpose such as discrete cosine and sine transforms (DCT, DST), as well as low frequency non-separable manually optimized transforms (LFNST).

### Variational Image Compression

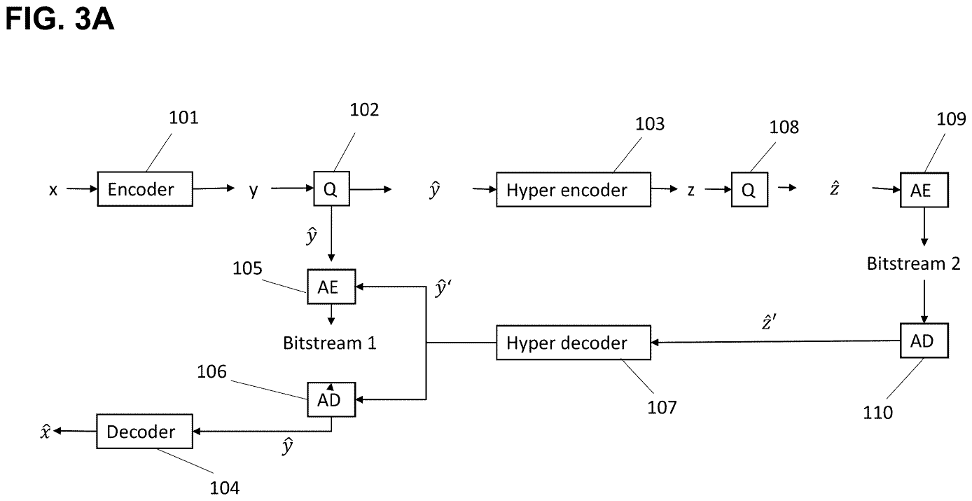

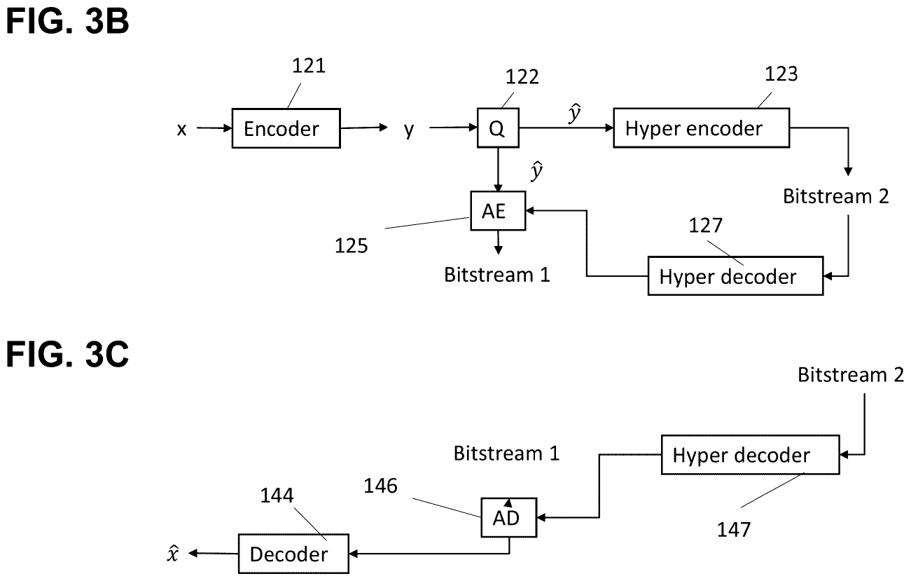

Variable Auto-Encoder (VAE) framework can be considered as a nonlinear transforming coding model. The transforming process can be mainly divided into four parts. This is exemplified in FIG. 3A showing a VAE framework.

The transforming process can be mainly divided into four parts: FIG. 3A exemplifies the VAE framework. In FIG. 3A, the encoder 101 maps an input image x into a latent representation (denoted by y) via the function y=f(x). This latent representation may also be referred to as a part of or a point within a “latent space” in the following. The function f( ) is a transformation function that converts the input signal x into a more compressible representation y. The quantizer 102 transforms the latent representation y into the quantized latent representation ŷ with (discrete) values by ŷ=Q(y), with Q representing the quantizer function. The entropy model, or the hyper encoder/decoder (also known as hyperprior) 103 estimates the distribution of the quantized latent representation ŷ to get the minimum rate achievable with a lossless entropy source coding.

The latent space can be understood as a representation of compressed data in which similar data points are closer together in the latent space. Latent space is useful for learning data features and for finding simpler representations of data for analysis. The quantized latent representation T, ŷ and the side information 2 of the hyperprior 3 are included into a bitstream 2 (are binarized) using arithmetic coding (AE). Furthermore, a decoder 104 is provided that transforms the quantized latent representation to the reconstructed image \hat{x}, \hat{x}=g(ŷ). The signal \hat{x} is the estimation of the input image x. It is desirable that x is as close to î as possible, in other words the reconstruction quality is as high as possible. However, the higher the similarity between \hat{x} and x, the higher the amount of side information necessary to be transmitted. The side information includes bitstream1 and bitstream2 shown in FIG. 3A, which are generated by the encoder and transmitted to the decoder. Normally, the higher the amount of side information, the higher the reconstruction quality. However, a high amount of side information means that the compression ratio is low. Therefore, one purpose of the system described in FIG. 3A is to balance the reconstruction quality and the amount of side information conveyed in the bitstream.

In FIG. 3A the component AE 105 is the Arithmetic Encoding module, which converts samples of the quantized latent representation ŷ and the side information \hat{z} into a binary representation bitstream 1. The samples of ŷ and \hat{z} might for example comprise integer or floating point numbers. One purpose of the arithmetic encoding module is to convert (via the process of binarization) the sample values into a string of binary digits (which is then included in the bitstream that may comprise further portions corresponding to the encoded image or further side information).

The arithmetic decoding (AD) 106 is the process of reverting the binarization process, where binary digits are converted back to sample values. The arithmetic decoding is provided by the arithmetic decoding module 106.

It is noted that the present disclosure is not limited to this particular framework. Moreover, the present disclosure is not restricted to image or video compression, and can be applied to object detection, image generation, and recognition systems as well.

In FIG. 3A there are two sub networks concatenated to each other. A subnetwork in this context is a logical division between the parts of the total network. For example, in FIG. 3A the modules 101, 102, 104, 105 and 106 are called the “Encoder/Decoder” subnetwork. The “Encoder/Decoder” subnetwork is responsible for encoding (generating) and decoding (parsing) of the first bitstream “bitstream1”. The second network in FIG. 3A comprises modules 103, 108, 109, 110 and 107 and is called “hyper encoder/decoder” subnetwork. The second subnetwork is responsible for generating the second bitstream “bitstream2”. The purposes of the two subnetworks are different.

The first subnetwork is responsible for:
the transformation 101 of the input image x into its latent representation y (which is easier to compress that x),
quantizing 102 the latent representation y into a quantized latent representation ŷ, compressing the quantized latent representation ŷ using the AE by the arithmetic encoding module 105 to obtain bitstream “bitstream 1”.
parsing the bitstream 1 via AD using the arithmetic decoding module 106, and
reconstructing 104 the reconstructed image (\hat{x}) using the parsed data.

The purpose of the second subnetwork is to obtain statistical properties (e.g. mean value, variance and correlations between samples of bitstream 1) of the samples of “bitstream1”, such that the compressing of bitstream 1 by first subnetwork is more efficient. The second subnetwork generates a second bitstream “bitstream2”, which comprises the said information (e.g. mean value, variance and correlations between samples of bitstream1).

The second network includes an encoding part which comprises transforming 103 of the quantized latent representation ŷ into side information z, quantizing the side information z into quantized side information \hat{z}, and encoding (e.g. binarizing) 109 the quantized side information \hat{z} into bitstream2. In this example, the binarization is performed by an arithmetic encoding (AE). A decoding part of the second network includes arithmetic decoding (AD) 110, which transforms the input bitstream2 into decoded quantized side information \hat{z}′. The \hat{z}′ might be identical to \hat{z}, since the arithmetic encoding end decoding operations are lossless compression methods. The decoded quantized side information \hat{z}′ is then transformed 107 into decoded side information ŷ′. ŷ′ represents the statistical properties of ŷ (e.g. mean value of samples of ŷ, or the variance of sample values or like). The decoded latent representation ŷ′ is then provided to the above-mentioned Arithmetic Encoder 105 and Arithmetic Decoder 106 to control the probability model of ŷ.

The FIG. 3A describes an example of VAE (variational auto encoder), details of which might be different in different implementations. For example in a specific implementation additional components might be present to more efficiently obtain the statistical properties of the samples of bitstream 1. In one such implementation a context modeler might be present, which targets extracting cross-correlation information of the bitstream 1. The statistical information provided by the second subnetwork might be used by AE (arithmetic encoder) 105 and AD (arithmetic decoder) 106 components.

FIG. 3A depicts the encoder and decoder in a single figure. As is clear to those skilled in the art, the encoder and the decoder may be, and very often are, embedded in mutually different devices.

FIG. 3B depicts the encoder and FIG. 3C depicts the decoder components of the VAE framework in isolation. As input, the encoder receives, according to some embodiments, a picture. The input picture may include one or more channels, such as colour channels or other kind of channels, e.g. depth channel or motion information channel, or the like. The output of the encoder (as shown in FIG. 3B) is a bitstream1 and a bitstream2. The bitstream1 is the output of the first sub-network of the encoder and the bitstream2 is the output of the second subnetwork of the encoder.

Similarly, in FIG. 3C, the two bitstreams, bitstream1 and bitstream2, are received as input and \hat{z}, which is the reconstructed (decoded) image, is generated at the output. As indicated above, the VAE can be split into different logical units that perform different actions. This is exemplified in FIGS. 3B and 3C so that FIG. 3B depicts components that participate in the encoding of a signal, like a video and provided encoded information. This encoded information is then received by the decoder components depicted in FIG. 3C for encoding, for example. It is noted that the components of the encoder and decoder denoted with numerals 12x and 14x may correspond in their function to the components referred to above in FIG. 3A and denoted with numerals 10x.

Specifically, as is seen in FIG. 3B, the encoder comprises the encoder 121 that transforms an input x into a signal y which is then provided to the quantizer 322. The quantizer 122 provides information to the arithmetic encoding module 125 and the hyper encoder 123. The hyper encoder 123 provides the bitstream2 already discussed above to the hyper decoder 147 that in turn provides the information to the arithmetic encoding module 105 (125).

The output of the arithmetic encoding module is the bitstream1. The bitstream1 and bitstream2 are the output of the encoding of the signal, which are then provided (transmitted) to the decoding process. Although the unit 101 (121) is called “encoder”, it is also possible to call the complete subnetwork described in FIG. 3B as “encoder”. The process of encoding in general means the unit (module) that converts an input to an encoded (e.g. compressed) output. It can be seen from FIG. 3B, that the unit 121 can be actually considered as a core of the whole subnetwork, since it performs the conversion of the input x into y, which is the compressed version of the x. The compression in the encoder 121 may be achieved, e.g. by applying a neural network, or in general any processing network with one or more layers. In such network, the compression may be performed by cascaded processing including downsampling which reduces size and/or number of channels of the input. Thus, the encoder may be referred to, e.g. as a neural network (NN) based encoder, or the like.

The remaining parts in the figure (quantization unit, hyper encoder, hyper decoder, arithmetic encoder/decoder) are all parts that either improve the efficiency of the encoding process or are responsible for converting the compressed output y into a series of bits (bitstream). Quantization may be provided to further compress the output of the NN encoder 121 by a lossy compression. The AE 125 in combination with the hyper encoder 123 and hyper decoder 127 used to configure the AE 125 may perform the binarization which may further compress the quantized signal by a lossless compression. Therefore, it is also possible to call the whole subnetwork in FIG. 3B an “encoder”.

A majority of Deep Learning (DL) based image/video compression systems reduce dimensionality of the signal before converting the signal into binary digits (bits). In the VAE framework for example, the encoder, which is a non-linear transform, maps the input image x into y, where y has a smaller width and height than x. Since the y has a smaller width and height, hence a smaller size, the (size of the) dimension of the signal is reduced, and, hence, it is easier to compress the signal y. It is noted that in general, the encoder does not necessarily need to reduce the size in both (or in general all) dimensions. Rather, some exemplary implementations may provide an encoder which reduces size only in one (or in general a subset of) dimension.

In J. Balle, L. Valero Laparra, and E. P. Simoncelli (2015). “Density Modeling of Images Using a Generalized Normalization Transformation”, In: arXiv e-prints, Presented at the 4th Int. Conf, for Learning Representations, 2016 (referred to in the following as “Balle”) the authors proposed a framework for end-to-end optimization of an image compression model based on nonlinear transforms. The authors optimize for Mean Squared Error (MSE), but use a more flexible transforms built from cascades of linear convolutions and nonlinearities. Specifically, authors use a generalized divisive normalization (GDN) joint nonlinearity that is inspired by models of neurons in biological visual systems, and has proven effective in Gaussianizing image densities. This cascaded transformation is followed by uniform scalar quantization (i.e., each element is rounded to the nearest integer), which effectively implements a parametric form of vector quantization on the original image space. The compressed image is reconstructed from these quantized values using an approximate parametric nonlinear inverse transform.

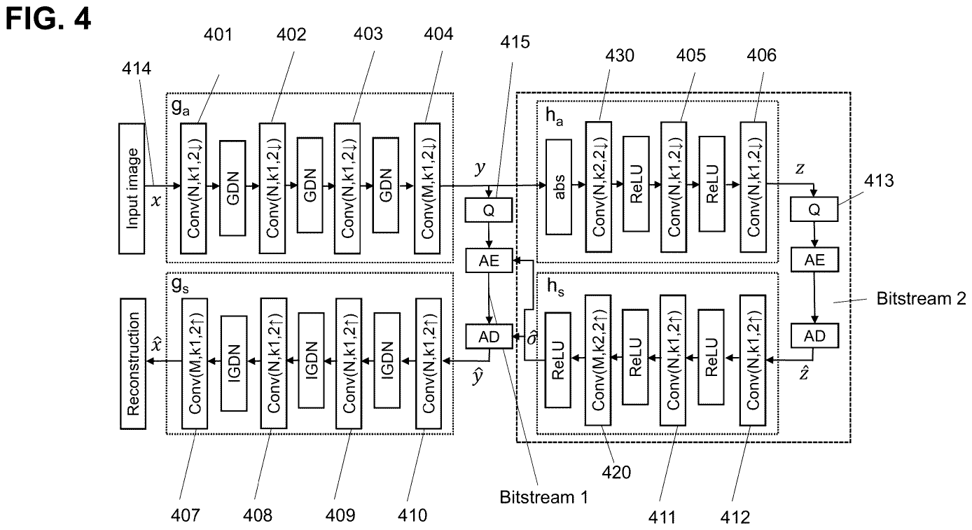

Such example of the VAE framework is shown in FIG. 4, and it utilizes 6 downsampling layers that are marked with 401 to 406. The network architecture includes a hyperprior model. The left side (gₐ, gₛ) shows an image autoencoder architecture, the right side (hₐ, hₛ) corresponds to the autoencoder implementing the hyperprior. The factorized-prior model uses the identical architecture for the analysis and synthesis transforms gₐ and gₛ. Q represents quantization, and AE, AD represent arithmetic encoder and arithmetic decoder, respectively. The encoder subjects the input image x to gₐ, yielding the responses y (latent representation) with spatially varying standard deviations. The encoding gₐ includes a plurality of convolution layers with subsampling and, as an activation function, generalized divisive normalization (GDN).

The responses are fed into hₐ, summarizing the distribution of standard deviations in z. z is then quantized, compressed, and transmitted as side information. The encoder then uses the quantized vector \hat{z} to estimate \hat{σ}, the spatial distribution of standard deviations which is used for obtaining probability values (or frequency values) for arithmetic coding (AE), and uses it to compress and transmit the quantized image representation ŷ (or latent representation). The decoder first recovers \hat{z} from the compressed signal. It then uses hₛ to obtain ŷ, which provides it with the correct probability estimates to successfully recover ŷ as well. It then feeds ŷ into gₛ to obtain the reconstructed image.

The layers that include downsampling is indicated with the downward arrow in the layer description. The layer description “Conv N,k1,2↓” means that the layer is a convolution layer, with N channels and the convolution kernel is k1×k1 in size. For example, k1 may be equal to 5 and k2 may be equal to 3. As stated, the 2↓ means that a downsampling with a factor of 2 is performed in this layer. Downsampling by a factor of 2 results in one of the dimensions of the input signal being reduced by half at the output. In FIG. 4, the 2↓ indicates that both width and height of the input image is reduced by a factor of 2. Since there are 6 downsampling layers, if the width and height of the input image 414 (also denoted with x) is given by w and h, the output signal z\hat{ }413 is has width and height equal to w/64 and h/64 respectively. Modules denoted by AE and AD are arithmetic encoder and arithmetic decoder, which are explained with reference to FIGS. 3A to 3C. The arithmetic encoder and decoder are specific implementations of entropy coding. AE and AD can be replaced by other means of entropy coding. In information theory, an entropy encoding is a lossless data compression scheme that is used to convert the values of a symbol into a binary representation which is a revertible process. Also, the “Q” in the figure corresponds to the quantization operation that was also referred to above in relation to FIG. 4 and is further explained above in the section “Quantization”. Also, the quantization operation and a corresponding quantization unit as part of the component 413 or 415 is not necessarily present and/or can be replaced with another unit.

In FIG. 4, there is also shown the decoder comprising upsampling layers 407 to 412. A further layer 420 is provided between the upsampling layers 411 and 410 in the processing order of an input that is implemented as convolutional layer but does not provide an upsampling to the input received. A corresponding convolutional layer 430 is also shown for the decoder. Such layers can be provided in NNs for performing operations on the input that do not alter the size of the input but change specific characteristics. However, it is not necessary that such a layer is provided.

When seen in the processing order of bitstream2 through the decoder, the upsampling layers are run through in reverse order, i.e. from upsampling layer 412 to upsampling layer 407. Each upsampling layer is shown here to provide an upsampling with an upsampling ratio of 2, which is indicated by the ↑. It is, of course, not necessarily the case that all upsampling layers have the same upsampling ratio and also other upsampling ratios like 3, 4, 8 or the like may be used. The layers 407 to 412 are implemented as convolutional layers (conv). Specifically, as they may be intended to provide an operation on the input that is reverse to that of the encoder, the upsampling layers may apply a deconvolution operation to the input received so that its size is increased by a factor corresponding to the upsampling ratio. However, the present disclosure is not generally limited to deconvolution and the upsampling may be performed in any other manner such as by bilinear interpolation between two neighboring samples, or by nearest neighbor sample copying, or the like.

In the first subnetwork, some convolutional layers (401 to 403) are followed by generalized divisive normalization (GDN) at the encoder side and by the inverse GDN (IGDN) at the decoder side. In the second subnetwork, the activation function applied is ReLu. It is noted that the present disclosure is not limited to such implementation and in general, other activation functions may be used instead of GDN or ReLu.

### Cloud Solutions for Machine Tasks

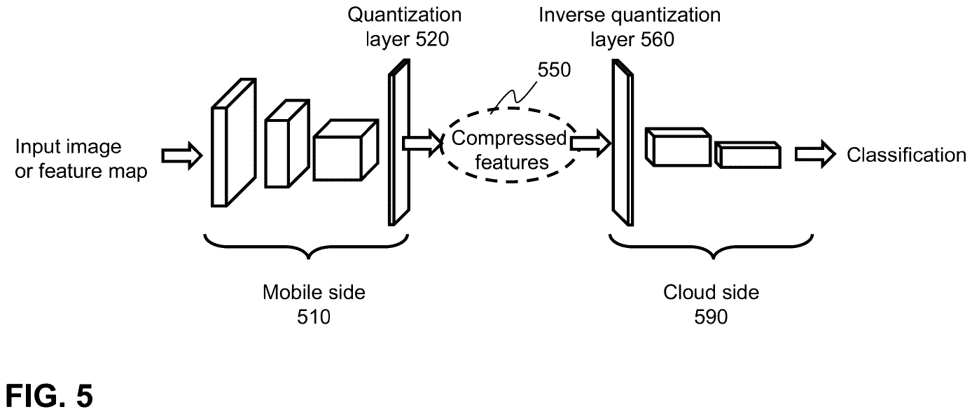

The Video Coding for Machines (VCM) is another computer science direction being popular nowadays. The main idea behind this approach is to transmit a coded representation of image or video information targeted to further processing by computer vision (CV) algorithms, like object segmentation, detection and recognition. In contrast to traditional image and video coding targeted to human perception the quality characteristic is the performance of computer vision task, e.g. object detection accuracy, rather than reconstructed quality. This is illustrated in FIG. 5.

Video Coding for Machines is also referred to as collaborative intelligence and it is a relatively new paradigm for efficient deployment of deep neural networks across the mobile-cloud infrastructure. By dividing the network between the mobile side 510 and the cloud side 590 (e.g. a cloud server), it is possible to distribute the computational workload such that the overall energy and/or latency of the system is minimized. In general, the collaborative intelligence is a paradigm where processing of a neural network is distributed between two or more different computation nodes; for example devices, but in general, any functionally defined nodes. Here, the term “node” does not refer to the above-mentioned neural network nodes. Rather the (computation) nodes here refer to (physically or at least logically) separate devices/modules, which implement parts of the neural network. Such devices may be different servers, different end user devices, a mixture of servers and/or user devices and/or cloud and/or processor or the like. In other words, the computation nodes may be considered as nodes belonging to the same neural network and communicating with each other to convey coded data within/for the neural network. For example, in order to be able to perform complex computations, one or more layers may be executed on a first device (such as a device on mobile side 510) and one or more layers may be executed in another device (such as a cloud server on cloud side 590). However, the distribution may also be finer and a single layer may be executed on a plurality of devices. In this disclosure, the term “plurality” refers to two or more. In some existing solution, a part of a neural network functionality is executed in a device (user device or edge device or the like) or a plurality of such devices and then the output (feature map) is passed to a cloud. A cloud is a collection of processing or computing systems that are located outside the device, which is operating the part of the neural network. The notion of collaborative intelligence has been extended to model training as well. In this case, data flows both ways: from the cloud to the mobile during back-propagation in training, and from the mobile to the cloud (illustrated in FIG. 5) during forward passes in training, as well as inference.

Some works presented semantic image compression by encoding deep features and then reconstructing the input image from them. The compression based on uniform quantization was shown, followed by context-based adaptive arithmetic coding (CABAC) from H.264. In some scenarios, it may be more efficient, to transmit from the mobile part 510 to the cloud 590 an output of a hidden layer (a deep feature map) 550, rather than sending compressed natural image data to the cloud and perform the object detection using reconstructed images. It may thus be advantageous to compress the data (features) generated by the mobile side 510, which may include a quantization layer 520 for this purpose. Correspondingly, the cloud side 590 may include an inverse quantization layer 560. The efficient compression of feature maps benefits the image and video compression and reconstruction both for human perception and for machine vision. Entropy coding methods, e.g. arithmetic coding is a popular approach to compression of deep features (i.e. feature maps).

Nowadays, video content contributes to more than 80% internet traffic, and the percentage is expected to increase even further. Therefore, it is critical to build an efficient video compression system and generate higher quality frames at given bandwidth budget. In addition, most video related computer vision tasks such as video object detection or video object tracking are sensitive to the quality of compressed videos, and efficient video compression may bring benefits for other computer vision tasks. Meanwhile, the techniques in video compression are also helpful for action recognition and model compression. However, in the past decades, video compression algorithms rely on hand-crafted modules, e.g., block based motion estimation and Discrete Cosine Transform (DCT), to reduce the redundancies in the video sequences, as mentioned above. Although each module is well designed, the whole compression system is not end-to-end optimized. It is desirable to further improve video compression performance by jointly optimizing the whole compression system.

### End-to-End Image or Video Compression

DNN based image compression methods can exploit large scale end-to-end training and highly non-linear transform, which are not used in the traditional approaches. However, it is non-trivial to directly apply these techniques to build an end-to-end learning system for video compression. First, it remains an open problem to learn how to generate and compress the motion information tailored for video compression. Video compression methods heavily rely on motion information to reduce temporal redundancy in video sequences.

A straightforward solution is to use the learning based optical flow to represent motion information. However, current learning based optical flow approaches aim at generating flow fields as accurate as possible. The precise optical flow is often not optimal for a particular video task. In addition, the data volume of optical flow increases significantly when compared with motion information in the traditional compression systems and directly applying the existing compression approaches to compress optical flow values will significantly increase the number of bits required for storing motion information. Second, it is unclear how to build a DNN based video compression system by minimizing the rate-distortion based objective for both residual and motion information. Rate-distortion optimization (RDO) aims at achieving higher quality of reconstructed frame (i.e., less distortion) when the number of bits (or bit rate) for compression is given. RDO is important for video compression performance. In order to exploit the power of end-to-end training for learning based compression system, the RDO strategy is required to optimize the whole system.

In Guo Lu, Wanli Ouyang, Dong Xu, Xiaoyun Zhang, Chunlei Cai, Zhiyong Gao; “DVC: An End-to-end Deep Video Compression Framework”. Proceedings of the IEEE/CVF Conference on Computer Vision and Pattern Recognition (CVPR), 2019, pp. 11006-11015, authors proposed the end-to-end deep video compression (DVC) model that jointly learns motion estimation, motion compression, and residual coding.

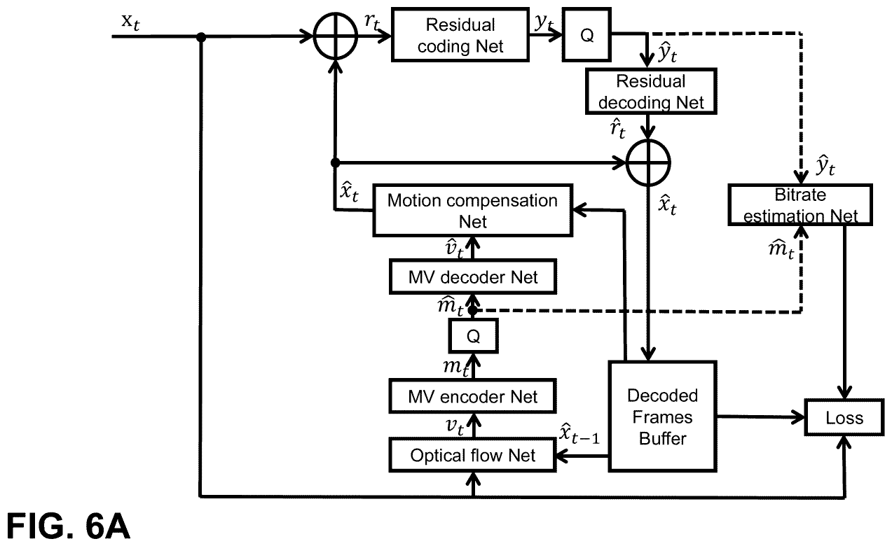

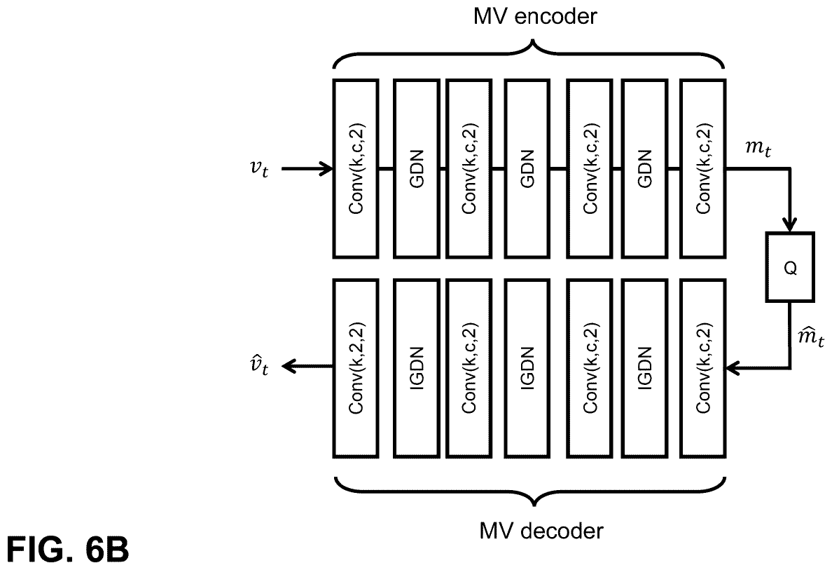

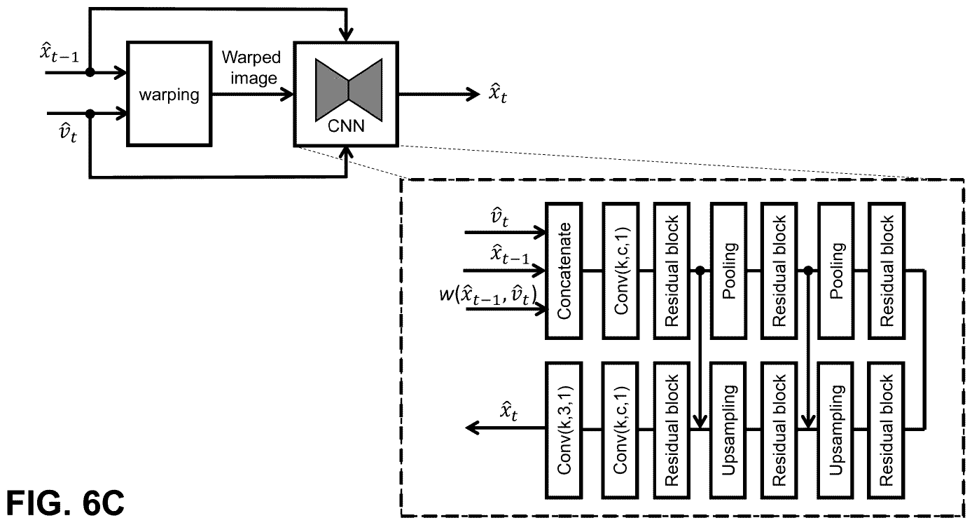

Such encoder is illustrated in FIG. 6A. In particular, FIG. 6A shows an overall structure of end-to-end trainable video compression framework. In order to compress motion information, a CNN was designated to transform the optical flow vₜ to the corresponding representations mₜ suitable for better compression. Specifically, an auto-encoder style network is used to compress the optical flow. The motion vectors (MV) compression network is shown in FIG. 6B. The network architecture is somewhat similar to the ga/gs of FIG. 4. In particular, the optical flow vₜ is fed into a series of convolution operation and nonlinear transform including GDN and IGDN. The number of output channels c for convolution (deconvolution) is here exemplarily 128 except for the last deconvolution layer, which is equal to 2 in this example. The kernel size is k, e.g. k=3. Given optical flow with the size of M×N×2, the MV encoder will generate the motion representation mₜ with the size of M/16×N/16×128. Then motion representation is quantized (Q), entropy coded and sent to bitstream as \hat{m}ₜ. The MV decoder receives the quantized representation \hat{m}ₜ and reconstruct motion information \hat{v}ₜ using MV encoder. In general, the values for k and c may differ from the above mentioned examples as is known from the art.

FIG. 6C shows a structure of the motion compensation part. Here, using previous reconstructed frame xₜ₋₁ and reconstructed motion information, the warping unit generates the warped frame (normally, with help of interpolation filter such as bi-linear interpolation filter). Then a separate CNN with three inputs generates the predicted picture. The architecture of the motion compensation CNN is also shown in FIG. 6C.

The residual information between the original frame and the predicted frame is encoded by the residual encoder network. A highly non-linear neural network is used to transform the residuals to the corresponding latent representation. Compared with discrete cosine transform in the traditional video compression system, this approach can better exploit the power of non-linear transform and achieve higher compression efficiency.

From above overview it can be seen that CNN based architecture can be applied both for image and video compression, considering different parts of video framework including motion estimation, motion compensation and residual coding. Entropy coding is popular method used for data compression, which is widely adopted by the industry and is also applicable for feature map compression either for human perception or for computer vision tasks.

### Video Coding for Machines

The Video Coding for Machines (VCM) is another computer science direction being popular nowadays. The main idea behind this approach is to transmit the coded representation of image or video information targeted to further processing by computer vision (CV) algorithms, like object segmentation, detection and recognition. In contrast to traditional image and video coding targeted to human perception the quality characteristic is the performance of computer vision task, e.g. object detection accuracy, rather than reconstructed quality.

A recent study proposed a new deployment paradigm called collaborative intelligence, whereby a deep model is split between the mobile and the cloud. Extensive experiments under various hardware configurations and wireless connectivity modes revealed that the optimal operating point in terms of energy consumption and/or computational latency involves splitting the model, usually at a point deep in the network. Today's common solutions, where the model sits fully in the cloud or fully at the mobile, were found to be rarely (if ever) optimal. The notion of collaborative intelligence has been extended to model training as well. In this case, data flows both ways: from the cloud to the mobile during back-propagation in training, and from the mobile to the cloud during forward passes in training, as well as inference.

Lossy compression of deep feature data has been studied based on HEVC intra coding, in the context of a recent deep model for object detection. It was noted the degradation of detection performance with increased compression levels and proposed compression-augmented training to minimize this loss by producing a model that is more robust to quantization noise in feature values. However, this is still a sub-optimal solution, because the codec employed is highly complex and optimized for natural scene compression rather than deep feature compression.

The problem of deep feature compression for the collaborative intelligence has been addressed by an approach for object detection task using popular YOLOv2 network for the study of compression efficiency and recognition accuracy trade-off. Here the term deep feature has the same meaning as feature map. The word ‘deep’ comes from the collaborative intelligence idea when the output feature map of some hidden (deep) layer is captured and transferred to the cloud to perform inference. That appears to be more efficient rather than sending compressed natural image data to the cloud and perform the object detection using reconstructed images.

The efficient compression of feature maps benefits the image and video compression and reconstruction both for human perception and for machine vision. Said about disadvantages of state-of-the art autoencoder based approach to compression are also valid for machine vision tasks.

In the present specification, a ‘parameter’ is a value used in an operation process of each layer forming a neural network, and for example, may include a weight used when an input value is applied to a certain operation expression. Here, the parameter may be expressed in a matrix form. The parameter is a value set as a result of training, and may be updated through separate training data when necessary.

Referring back to FIG. 3A, the input image x may be comprised of 3 channels (these may be typically YUV or RGB). The encoder 101 and decoder 104 are trained together, with the aim that the decoded image is close representation of the input image, and the encoded image (y) is smaller than the input.

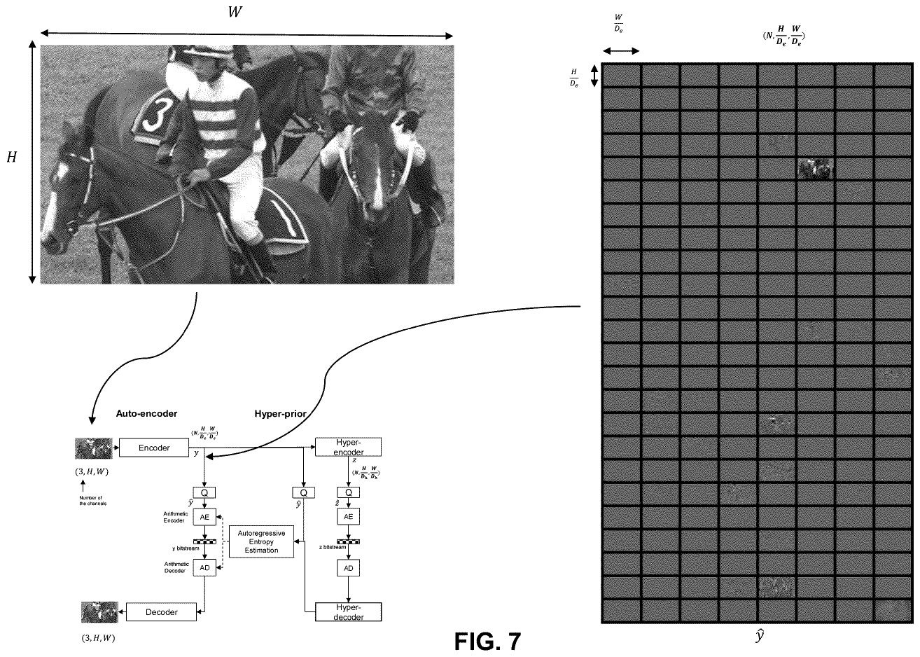

The encoded image y is quantized to produce y\hat{ }. FIG. 7 gives an example of the contents of a y\hat{ }. It may comprise of multiple low-resolution versions of the input image, most of which do not carry a visual information. An arithmetic encoder 105 in FIG. 3A is producing the y-bitstream to be transmitted. At the decoder, the bitstream is going through arithmetic decoder 106 and image decoder 105. The image encoder is a lossy encoder, the arithmetic encoder is a lossless one. The entropy estimation in the arithmetic encoder is of critical importance for the compression efficiency. The entropy estimation network positioned downstream of the hyper-decoder and providing inputs to the arithmetic encoder 105 and the arithmetic decoder 106. The entropy estimation network may be trained to do accurate entropy estimation, so that the frequently occurring elements in y\hat{ } are represented by shorter bit-sequences in the bitstream. The Entropy estimation is aided by a structure called hyper-prior, which is working in a similar way to the auto-encoder, but on a downsampled version of the input image.

To achieve different levels of compression, the whole system may be trained a number of times with different optimization goals—targeting different quality vs size trade-off. Additionally, different levels of quantization may be applied. Each quality point is a result of different optimization, and it might happen that each quality point has slightly different artefacts. Quality points may be thought of parameters that identify the compression levels that are used and/or the encoder that is used to obtain the image compression levels.

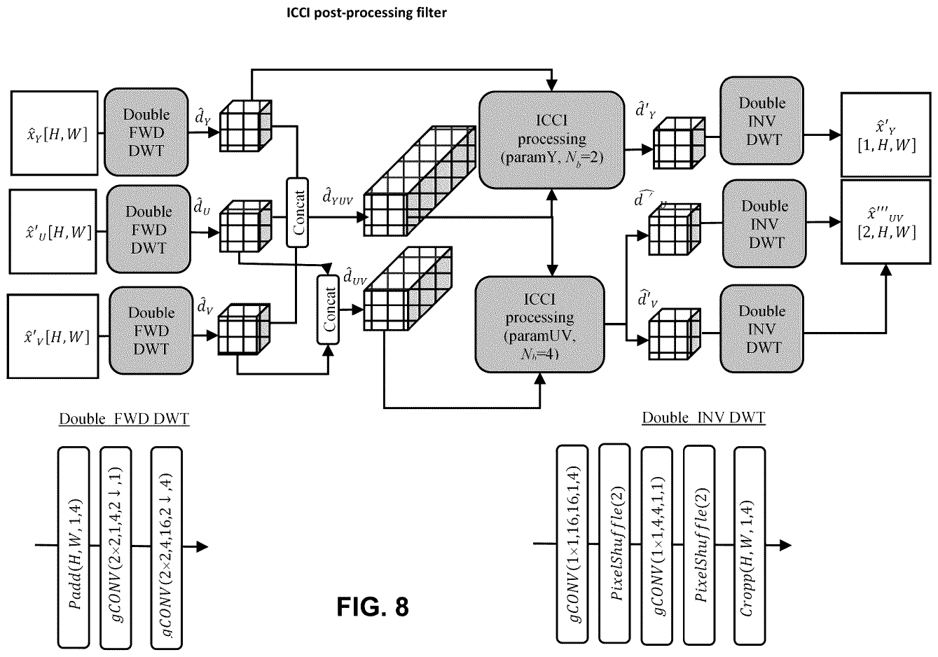

To reduce the output artefacts, the decoded image may be usually fed to a post-processing image optimization filter. An example of the post-processing filter is shown generally in FIG. 8. The filter may be a neural network, which takes a number of image components (e.g. R/G/B or Y/U/V), and assigns one component to be the primary one. It may enhance the primary component, and uses the rest of the components as a side information to help the enhancement. A number of different versions of the same filter are trained, each one with slightly different optimization goal. All filters have identical structure, but different weights in the network. In the decoder, the reconstructed image x\hat{ }is fed to the enhancement filter. In the metadata of the image, there may be a signal to determine which component is the primary one (to be enhanced) and a signal to determine which filter number (index in the dictionally of filters) to be used. Based on the index, the appropriate set of coefficients (weights) may be loaded, and the network processing is executed.

The present disclosure addresses the case in which a post-processing AI filter is used to enhance the output of an AI-based image codec. The codec may be separately trained for different quality factors (quality points). The filter may be trained to enhance the output of the AI codec, also separately on the output for each quality point, and separately for each colour component. Additionally, the filter used may be trained with different optimization criteria. This results in a dictionary of filters (which may be understood as a filter bank) which could be applied to the output of the codec. The number of the filter to be applied to the image may be signalled with the image. Which filter most faithfully reproduces the input image and thus performs best may depend both on the quality point and the image content. In some cases, different filter number is applied to different components, and to different patches of the image. It is also possible to turn off the post-processing for some components or some patches of the input image, for example by only applying the filter to the Y component but not the UV chroma component, or to the UV chroma component but not the luma component.

In order to determine the best filter for an image region, typically the encoder would need to run all filters in the bank on the same patch and compare each of these processed outputs with the desired output. This is a computationally intensive operation. It has been observed, that for each codec there are two filters from the bank of filters that are most frequently used for each quality point, but that two filters may be different for each quality point. In other words, each codec in the reconstruction of the image utilises two of the potential bank of filters in most cases in order to produce the best reproduction of the input image.

Due to the intensive computational burden that assessing each filter requires and given the observed commonality of filters of best filters for each codec, the present disclosure provides an optimized signalling that assigns shorter messages to the most commonly used filters. The device for decoding as described herein may use a partial message sent by the encoder, and the model parameters (quality point) to recover the full index of the filter to be used. As such, this disclosure provides a message structure that is optimized for a post-processing filter selection to be proposed in the JPEG-AI standard.

The following further describes the current implementation of the Inter Channel Correlation Information filter using discrete wavelet transform (ICCI-DWT) proposed to the JPEG-AI. The current disclosure does not change the structure of the filter, only the structure of the signalling. The structure of the filter will be briefly described for clarity. The JPEG-AI filter implementation is a specifically configured to have very low complexity.

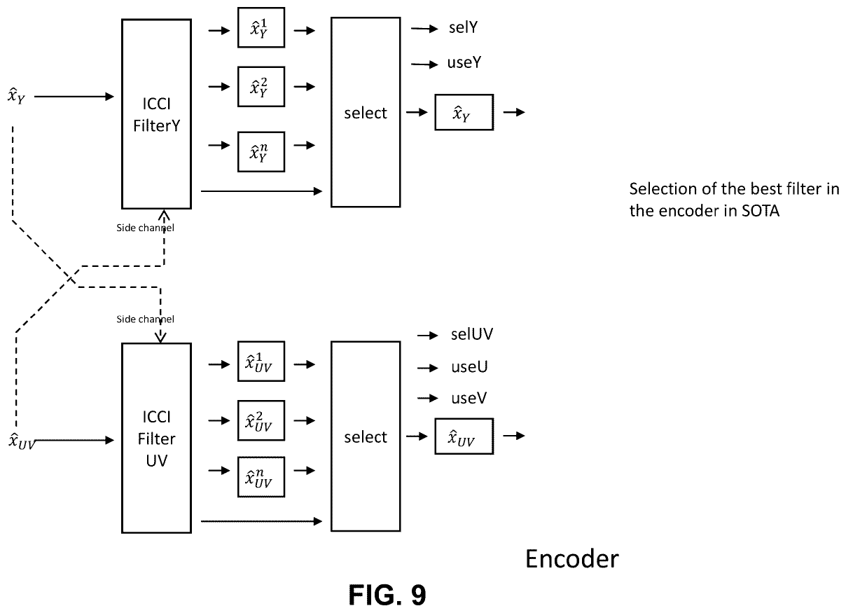

The general structure of the filter is shown in FIG. 8 and further shown in FIG. 9. The filter operates on YUV channel input. Each of the three channels passes through a DWT transform twice, and then is fed to two networks. One network improves luma Y with the help of chroma UV (using UV as side channels), the other improves chroma UV using luma Y as a side channel. We can select one filter index (one set of weights) for the luma Y, and another filter index for the chroma UV. Processing of chroma UV components may be done in a single pass, so U and V may be processed using the same filter index.

The current implementation of ICCI-DWT filter selection in the encoder is shown in FIG. 9. The reconstructed image x\hat{ }is fed to the ICCI-DWT filter. The luma component x\hat{ }_{Y} is fed to the ICCI-Y filter, the two chroma components x′uv are fed to the UV filter. In this version, there are ten trained ten luma Y filters and ten trained chroma UV filters. Each filter processes 10 different versions of its input. (20 runs in total, 10 Y filters and 10 UV filters). The “select” blocks choose between the ten processed image versions by each of the filters and the original image version. This may be achieved by comparing the filter processed images to the uncompressed image using mean square error (MSE). To do this the encoder always has access to the uncompressed image and thus is able to perform the comparison. The best output, e.g., the most faithful representation representing the closest output to the desired one may be selected for output. Additionally, five signals are produced by the encoder and sent to the decoder. These five signals are as follows, selY, selUV, useY, useU, useV. The first, selY is the filter number to be used for luma Y component in other words selY is a luma filter index of each luma filter in the dictionary, selUV is the filter number to be used for the chroma components in other words selUV is a chroma filter index of each chroma filter in the dictionary. Both of these signals selY and selUV may be thought of as filter index information that comprises a luma filter index and a chroma filter index. The signal useY is a binary flag indicating if we use the filter output or use the unprocessed x\hat{ }_{Y}.

The situation with the UV filter is analogous, but slightly different in that in order to minimize the computational requirement, the UV channels are always processed together, using the same filter index. However, U and V output can be turned off separately. For example, if selUV=5, useU=false and useV=true, both chroma components are processed with ICCI UV filter with index 5, but in the output, the processed U component is replaced with the unprocessed U component from x\hat{ }_{UV}.

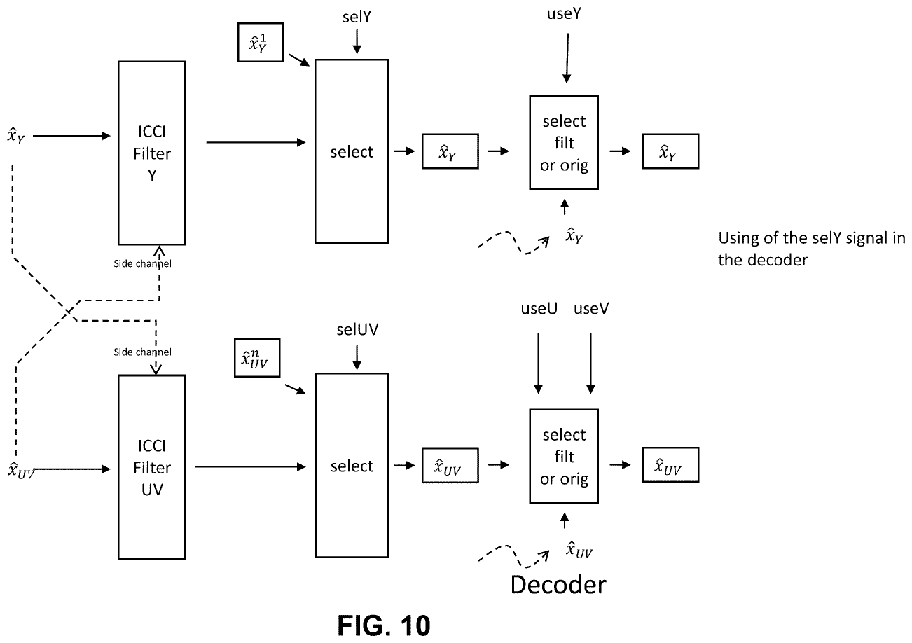

An example of a decoder is shown in FIG. 10. The input to the ICCI-DWT filter is x\hat{ }_{Y} and x\hat{ }_{UV}. The selY and selUV signal is used to select a filter from the filter bank of n filters, and then ICCI-DWT-Y and ICCI-DWT-UV filters are run in parallel. The use Y, useU and use V signals are used to decide if processed or unprocessed components of x\hat{ }_{Y} and x\hat{ }_{UV} will be output. The current implementation always runs the ICCI filter, even if all of use Y, useU and useV are false. However, in some cases it is beneficial that some parts of the filter do not execute, for example when one of the U or V chroma are turned off (deactivated) and as such it would be beneficial to alter the syntax of the metadata as may be done in the implementation of this disclosure and discussed below. In such a case in which one of the chroma components is deactivated (false) the deactivated component will then be represented by the original component of the image that was input.

The present disclosure therefore provides a changed signalling syntax as part of a method of decoding and device for decoding to accommodate the following three goals: (1) assign a shorter message to the filters which are used more often; (2) change the syntax in order to save memory and computation effort by turning off (deactivating) the processing of filter branches which are not needed; and (3) enable faster encoding speed by testing only 2 filters instead of all 10, while still keeping the option to signal the full filter index. These goals are also borne in mind of the specifics of the JPEG-AI implementation where U and V channels are always processed together.

As briefly discussed above, in the majority of cases for each encoder, there will be two filters which will produce the best reproduction of the image input being decoded. However, the two filters for each encoder (quality point) and for each channel of the image (Y, U, V) may be different and as such a dictionary of pairs of common filters should be provided from which a selection of the chosen filter can be made. This dictionary of filters may be generated using a test image dataset of hundreds of thousands of images which are each compressed for every compression level for which an encoder will be used and then each image may be tested against all the of the combinations of filters possible for that encoder. A comparison of the output processed images for each compression level and for each filter may then be compared using a mean squared error calculation or other similar and suitable loss function in comparison to the desired reproduced image. Once this comparison has been made, a selection may be made in which two filters are selected that produce the best output for the decoded image. This pairing with be used for that encoder for both the luma Y and the chroma UV components of the image. The same filter pairing will be considered the most efficient for both the luma and chroma filtering of the image in the present disclosure in order to reduce the computational workload. The two best filters for each codec may then be added to a tabular list comprised of the two best filters for each codec, such a list can be thought of as the short list from which the two best filters for image processing for that codec can be looked up.

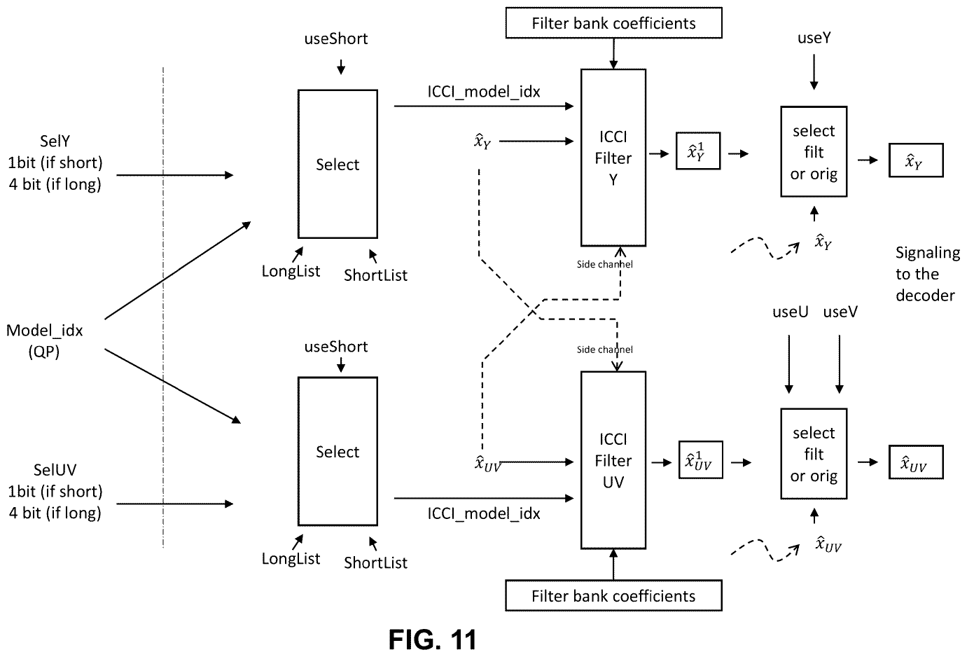

FIG. 11 presents an example of the method for decoding and apparatus for decoding according to the present disclosure. The apparatus of this disclosure may comprise one or more processors configured to perform the below functions and implement the method steps described herein and shown in FIGS. 11 to 13. In particular FIG. 11 demonstrates an example of how the different signalling syntax will be used by the decoder. The decoder of this disclosure is adapted from the norm to consider both explicit signals from the encoder as well as implicit signals. The implicit signals may be inferred by the decoder from the parameters of the codec in question and the compression level used. The apparatus and method of this disclosure may be configured to receive a bitstream comprising an image to be decoded. The apparatus for decoding according to the present disclosure may therefore be configured to determine one or more neural network based encoder model parameters based on a codec index which identifies the codec. The codec index is shown in FIG. 11 as the model_idx representing the quality point for each codec. The Quality point, or QP is a numerical value associated with a particular compression level. Each quality point may represent a different trade-off between stream size and quality loss. A lower the quality point number represents a smaller stream size and lower quality. In this way the apparatus can determine the compression level being used and the specific codec, the output of which it will decode. The apparatus may then be configured to determine a plurality of filter lists comprised of a short list and a long list of luma filters, and a short list and a long list of chroma filters based on the determined one or more neural network based encoder model parameters.

FIG. 11 demonstrates that the apparatus for decoding is configured to receive a plurality of signals which may come from the encoder. These signals may be thought of as explicit signals. The plurality of signals may comprise filter index information, filter list information, and filter selection information. The filter index information may be comprised of comprising a luma filter index (selY) and a chroma filter index (selUV) which may provide a dictionary of the luma filters and chroma filters respectively that are associated with that codec. In other words, the luma filter index and the chroma filter index may comprise a list of the luma and chroma filters that may be used to process the image. The length of these signals may depend on whether the short list or the long list of filters is to be used for example, 3 bit or 4 bit respectively. In addition, when selY is true (selY=1) then this may indicate a single filter from the short list and when selY is false (selY=0) then this may indicate (provide an indication) of an alternate filter from the short list. The same is true in the case that the selY is true and false and the long list is selected. Furthermore, selUV may operate in the same way when true or false in order to select a filter from short or long lists.

The filter list information (useShort) may be comprised of an indication of a length of a luma filter list to be used and an indication of a length of a chroma filter list to be used. In other words, the filter list information may comprise a bit of information, possibly in binary form, that indicates whether a short list (shortList) of filters, or a long list (longList) of filters are to be used to process an image that is input and assessed for reproductive quality. These short lists and long lists may be comprised of filters from a filter dictionary that are specific to the codec in question. More specifically, the short list of luma filters will be comprised of two or more luma filters of the luma filter index that are the most frequently applied for the codec and the long list of chroma filters is comprised of two or more of chroma filters from the chroma filter index that are the most frequently applied for the codec. In other words, the two most commonly utilised filters that produce the best reproduction of the input image when decoding will be included in the short list of the luma and chroma filter lists. In once scenario the shortList may be considered a pre-calculated table listing the indices of the two most used filters for each quality point and the longList may be a pre-calculated table listing the indices of filters to be used if useShort is false.

In a first embodiment the remainder of the filters that are not included in the short list of luma filters and the short list of chroma filters will be included in the long list of luma filters and the long list of chroma filters that are determined by the apparatus as part of the plurality of filter lists. In a second embodiment the long list of luma filters and the long list of chroma filters may include all the possible filters for that codec irrespective of whether two or more of these filters have been included in the short lists for each of the luma and chroma.

In addition, the apparatus may be configured to receive a further explicit signal, the signal being a filter selection information for determining a luma filter and a chroma filter to be used to decode the image. The filter selection information is shown in FIG. 11 as the use Y, useU and useV signals. These filter selection information signals may be comprised of binary information indicating whether each luma or chroma filter separately and distinctly are activated. In this way it is possible to determine whether to process the input image using each filter or the unprocessed image.

In the apparatus for decoding according to this disclosure the apparatus may be configured to select a short list of luma filters or a long list of luma filters based on the determined one or more neural network based encoder model parameters, the determined filter lists and the received plurality of signals. The apparatus may also be configured to select a short list of chroma filters a long list of chroma filters for processing the image based on the determined one or more neural network based encoder model parameters, the determined filter lists and the received plurality of signals. In other words, as shown in FIG. 11 the apparatus will select a filter list from either the short list or the long list for either/or the luma or chroma filters based on the received explicit signal useShort as to whether to use the short or long list for that codec. Specifically, if the useShort signal is set to true, then both selY and selUV indexes may be represented by 1 bit as the short list has been selected and thus at least one out of 2 top filters for the current quality point are indicated by the ICCI model idx that is passed to the ICCI filter. If useShort flag is false, then the long list has been selected and both selY and selUV indices are represented by 3 or 4-bits. The filter that is selected for application with the ICCI filter Y/UV in FIG. 11 will be made based on the input of the QP, useShort and selY/UV signals so as to pass an index of the chosen filter to the ICCI filter for luma Y or chroma UV. The 3 or 4-bit representation may represent one of up to 10 possible filters (8 for the short list and 10 for the long list). It is a very rare occurrence that one colour component, for example the luma, is using a filter from the short list, and the colour component, for example the chroma, is using a filter from the long list. For this reason, the present apparatus is configured to use a single a single useShort signal to determine the length of both selY and selUV filter lists. This selection of the short list or the long list allows the apparatus to reduce the computational workload by reducing the number of filters considered to process the input image.

The apparatus for decoding may therefore utilise the select block shown in FIG. 11, which receives the explicit signals selY, selUV, useShort, useY, useU and useV, together with the implicit information coming from model_idx (allows to deduce QP), longlist and shortList (pre-calculated tables of indices for each quality point) to infer the full filter model index ICCI_model_idx based on the selected list of filters. The apparatus is then configured to process the image using the selected filter from the short list of luma filters or the long list of luma filters, and/or the short list of chroma filters or the long list of chroma filters. This may be achieved as shown in FIG. 11 by the providing of the ICCI_model_idx to the ICCI filter Y or ICCI filter UV. In other words, the ICCI filter shown in FIG. 11 may output an image that has been processed by a single selected filter for each of Y and UV components, e.g., one processed image (colour component of that image) for the luma component and one for the chroma component. Model_idx may be the model number, where each number is a different quality point (QP). The ICCI_model_idx may be a number between 1 and 16, which indicates which filter is to be applied from the filter bank coefficients input to the ICCI filter and by the ICCI filter. All ICCI filters may have an identical structure and differ only in the coefficients (or weights) of the network. In this disclosure the ICCI_model_idx is provided to the filter, so it knows which weights to load before processing. Each of the colour components, luma and chroma, of the image may be processed separately as luma taking information from the chroma filter as a side channel, or the joint processing or the chroma components taking information from the luma filter input. This produces a series of filtered images in FIG. 11.

The apparatus and method for decoding may then, on processing the image using the luma filter from the selected short list luma filter or the long list luma filter, and/or the chroma filter from the short list chroma filter or the long list chroma filter, select whether to use the processed image or the image in the bitstream prior to processing based on the filter selection information.

The selection of the processed image or the image in the bitstream prior to processing may be made based on the filter selection information (useY or useUV) which may be generated as follows by an encoder. The encoder may be configured to receive the original image or a bitstream containing the original image and call a decoder (the decoder on the encoder side), to generate a reconstructed image. The encoder may then be configured to process the image using one or more different ICCI filters in turn one after the other, and create post-processed reconstructed images. Once these post-processed reconstructed images have been generated, the encoder may be configured to compare the quality loss between the original image, and each post-processed reconstructed image. The encoder may then select a filter that it determines to be the best filter that produces the most faithful reconstruction and generates a signal indicating these instructions (which may include filter selection signal) to the signal stream to be received by the apparatus for decoding according to this disclosure.

In other words, the encoder may determine a quality loss for each luma filter and/or a chroma filter selected from the filter selection information. This may be achieved by comparing the image processed by the filters from the filter selection information to the original image. Said another way, the encoder may be configured to determine a quality loss for each luma filter and/or a chroma filter used by the luma filter model and/or a chroma filter model by comparing each luma filter and/or a chroma filter used by the luma filter model and/or a chroma filter model to the original image. In this way, the encoder may be configured to compare each luma filter and/or a chroma filter used by the luma filter model and/or a chroma filter model (ICCI filter) to the original image. The quality loss may be generated by any suitable loss function as previously described in this disclosure.

The encoder may then be configured to select the luma and/or chroma filtered image or the originally input image (the image input to the filter \hat{x}_{Y} or \hat{x}_{UV}) that has the lowest quality loss based on the determined quality loss of each luma filter and/or a chroma filter used by the luma filter model and/or a chroma filter model and each luma filter and/or a chroma filter selected from the filter selection information. The ICCI filter Y or ICCI filter UV is used in FIG. 11 to process the image input as part of the bitstream based on the selection made by the encoder and signalled based on the signals useY, useU, useV which are used to determine if the processed or the unprocessed image output is used for each channel.

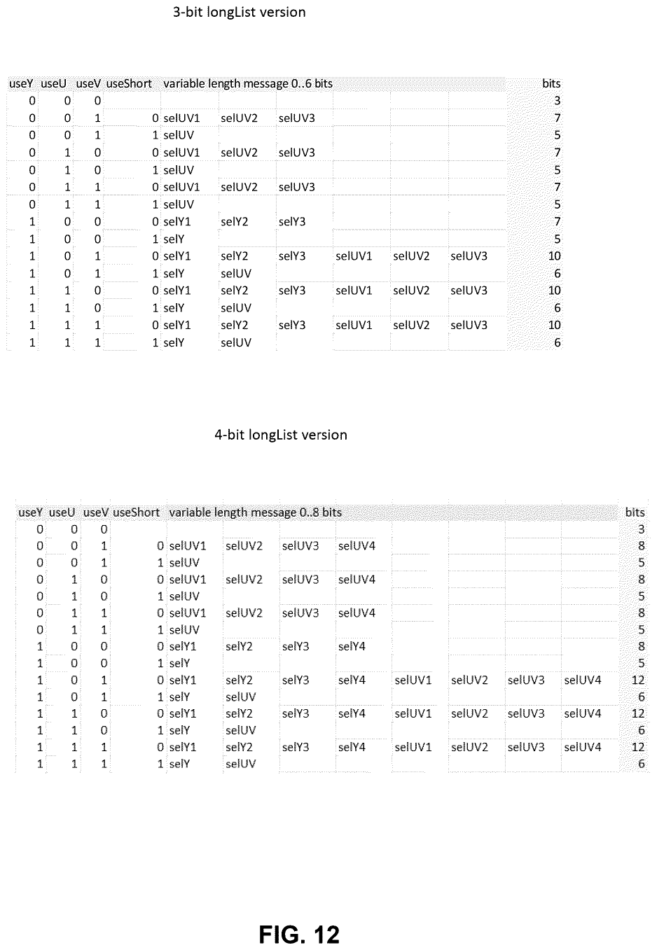

The processed image output represents a decoded and filtered image, while the unprocessed image output represents the decoded but unfiltered image. If useY in FIG. 11 is false, the ICCI-Y branch of the filter is not executed at all, and if useU and useV are both false (i.e. useU+useV=0, where “+” indicated OR operation), then the ICCI-UV branch of the filter is not executed at all. When a branch is not executed at all then the original input image that forms part of the bitstream is used for that colour component. This is further described in relation to FIG. 12. When one or more of the luma and/or chroma filter are not activated e.g., useY, useU or useV are false, then the filter used for processing the image may be the luma and/or chroma filter from the received filter index information. This disclosure provides two alternative implementations of the apparatus and method for decoding described herein. These two implementations may be thought of as a 3-bit longList and a 4-bit longlist respectively.

In the at least 3-bit longList the shortList and longList contain different filters indices—i.e. the two “most commonly used” indices in the shortList do not appear in the long list. In other words, the shortList and the longList for each of the luma and chroma colour components each comprise different filters from the filter index information, such that if for example a filter from the luma filter index is included in the luma shortList, it will not also be included in the luma longList. This allows the 10 filters that are currently used by the apparatus to be separated into a short group of 2 filters forming the shortList and long group of 8 filters forming the longList. The first group may be addressed with one bit in the selY or selUV signal and the second group may be addressed, in the first implementation, with 3 bits in the selY or selUV signal. The advantage of this implementation is that a bit saving can be achieved when signalling the shortList. However, the disadvantage is that because the filters included in the shortList are not repeated in the longList of filters then there is an inability to address certain combinations of selY and selUV indices, e.g., filter combinations. Furthermore, since the signal of useShort in FIG. 11 is shared between the signals selY and selUV, when a selection is made that the filter from signal selY is from the short list, then the filter chosen from the signal selUV must also be from the short list as well.

In the at least 4-bit longList, the longList can contain 16 indices (filters), and thus this allows for the case when each filter from the filter index information appears in both lists. In the 4-bit case, it is possible to utilise any combination of filters from the signals selY and selUV, when utilising the longList. In other words, all the filters of the filter index information will be included in the longList and the filters included in the shortList will also be contained within the longList. While this allows all combinations of filters to be possible, it increases the computational workload. There is rarely a need to utilise the full list of filter combinations as the majority processing iterations would be served by utilising the two most commonly used filters contained in the shortList for each codec.

In summary, when the long list of luma filters and the long list of chroma filters are each represented by at least 3 bits, the long list of luma filters comprises the filters from the luma filter index that are not comprised in the short list, and the long list of chroma filters comprises the filters from the chroma filter index that are not comprised in the short list. When the long list of luma filters and the long list of chroma filters are each represented by at least 4 bits, the long list of luma filters comprises all of the filters from the luma filter index, and the long list of chroma filters comprises all of the filters from the chroma filter index. Further discussion of the 3-bit and 4 bit implementation of the “sel” signals in combination with the shortList can be seen in FIG. 12.

FIG. 12 shows an example of the detailed structure of the signalling. There are described the two implementations discussed herein, namely a 3-bit longList and a 4-bit longList, which differ in the number of the bits used for the long filter selection message e.g., the filter index information representing the list of the filters.

The general filter structure discussed herein (ICCI-DWT in JPEG-AI) can run separate filters for Y and for UV components (the same filter is used for U and V channels). The codec has 5 different quality point models, and the decoder knows the current compression level/compression model index. The total number of trained filters may be 20, ten filters may be trained for enhancing the Y channel, and ten filters may be trained for enhancing the UV channels. Filtering of each channel (Y, U or V) can be turned on or off separately as discussed above.

In relation to FIG. 11 and FIG. 12 the following signals are used:

The useY, useU, useV signals which represent whether each filter should be used for the corresponding channel e.g., activated or deactivated. A useShort signal which if true, a short (partial) message is used to select the two filters to be used. If false, a long message may be used to select all filters to be used from the filter list. The selY, selUV signals may be represented by one-bit (short) messages to indicate the Y and/or UV filters to be used from the shortList. The selY1 . . . selY3/selY4, selUV3/selUV4 represent the 3-bit or 4-bit long messages to indicate Y and/or UV filters to be used. In the 3-bit longList version those messages are 3 bits long, and can address 8 filters. In the 4-bit longList version those messages are 4 bits long, and can address 16 filters. As can be seen in FIG. 12 the useY, useU, useV signals are represented as binary switches that activate (1) or deactivate (0) the colour component of the image to be filtered. The useShort signal is also binary and represents an indication regarding whether to use the two or more filters from the shortList (1) or the filters from the longList (0). FIG. 12 demonstrates that when the useShort signal is true the size of the “sel” message is adapted to be a 1 bit representation and when the useShort signal is false the size of the “sel” message is adapted to be a 3 or 4 bit representation of each filter/filter list. FIG. 12 also demonstrates the total number of bits the signalling of each configuration will utilise.

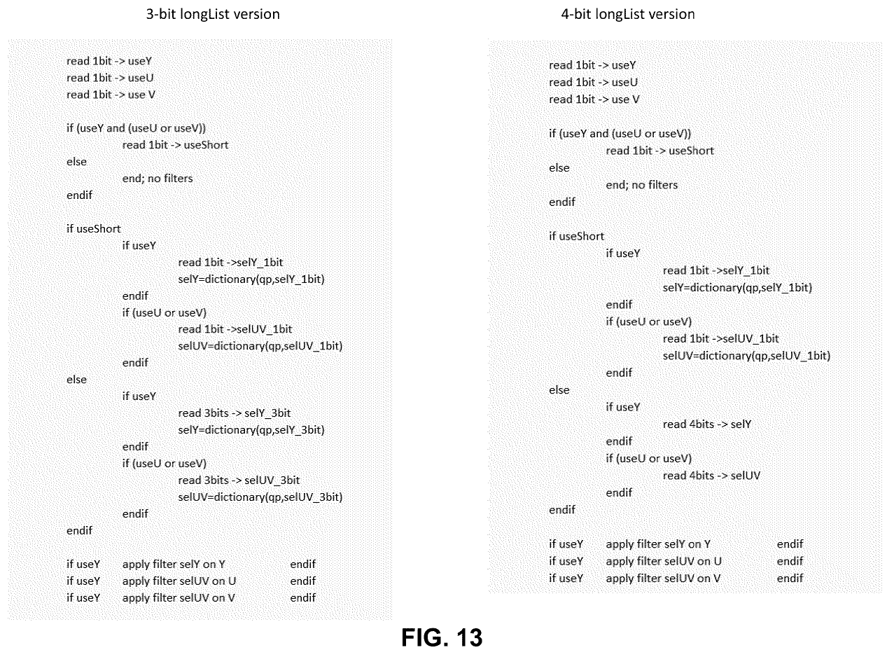

Furthermore, a number of variables can be seen used in the example code of FIG. 13. These variables are as follows and as discussed above in relation to FIG. 11. The shortList may be represented by a 2×5×2 table, which lists the two “most common filter indices” for each of the 5 example quality points, and each of the channel options (Y or UV). Of course, it should be understood that the number of quality points may be greater or less than 5 and 5 quality points is given purely as an example. The longList (3-bit version) may be represented by a 8×5×2 table, which lists the eight remaining filter indices (filters from the filter index information) for each of the 5 Qps, and each of the channel options (Y or UV). In this version, a filter index can be present only in one of the tables. This allows common indices (common filters) for Y to be combined only with common indices for UV. There is also the alternate implementation in which the longList (4-bit version) is represented by a 4-bit signal (message) that directly addresses a filter index, in other words in the 4 bit version the signal represents every possible filter for that codec listed in the filter index information and a separate longList is not required. Such a longList however may still be present for backwards compatibility. In this version it is possible for the apparatus and method to select any combination of Y-filter and UV filter for image processing.

An example of the steps of the method in relation to the algorithm of FIG. 13 will now be described. This algorithm is provided by way of an example only and provides understanding about how the apparatus and method of this disclosure may be implemented.

Firstly, the use Y, useU, useV signals are sent, to allow the decoder to make decision about memory and GPU allocation. If all three are false, nothing is sent anymore, no filters are used. In other words, when the filter selection information for determining a luma filter and a chroma filter to be used to decode the image indicates that both the luma filter and the chroma filter are false, then no filter is applied to the image in the bitstream. If, however, at least one of use Y, useU, useV is true, then useShort is signalled. If use Y is true, and neither of useU and useV are true, only selY is signalled. If use Y is false, and at least one of useU or useV is true, only selUV is signalled. If useY is true, and at least one of useU or useV is true, selY is signalled, and then selUV is signalled. If useShort is true, only one bit is signalled for selY and/or selUV. The decoder uses the shortList and the quality point value to deduce the filter index for Y and/or UV e.g., the apparatus determines which filter list should be used for Y and/or UV. If useShort is false, and the 3-bit longList version is used, 3 bits are signalled for each of selY and/or selUV. The decoder uses the longList and the quality point value to deduce the filter index for Y and/or UV. If useShort is false, and the 4-bit longList version is used, 4 bits are signalled for each of selY and/or selUV. The four bits may contain directly the entire filter index to be used for Y-filter or UV-filter respectively. FIG. 12 shows the algorithm for reading the filter selection messages “sel”, for 3-bit and 4-bit versions of the longList. Both algorithms differ in how many bits are consecutively read when useShort is false.

To briefly summarize the algorithm again that may be implemented by the apparatus and method for decoding of this disclosure, the following example may be true. First, the use Y, useU, useV flags are read in this order. If all three are zeroes, the algorithm stops, no filters are applied. Otherwise, one bit is read and stored in the useShort signal. If useShort is true and useY is true one bit is read into the selY, and a dictionary is used to obtain the selY index. In other words, the filter list information indicates that the length of the luma filter list to be used is short then the short list of luma filters is indicated as true, and the length of the chroma filter list to be used is also short then the short list of chroma filters is indicated as true. If useShort is true and least one of useU or useV is true one bit is read into the selUV, and a dictionary is used to obtain the full selUV index. If useShort is false, the same operation is carried one, but this time 3 or 4 bits are read into selY or selUV variables respectively. In the 3-bit longList version, after 3 bits are read, the longList is used to obtain the filter index. In the 4-bit longlist version, the 4 bits that are read are directly used as a filter index. The 3-bit and 4-bit versions of the signalling are mutually exclusive.

While operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

Herein there is provided a signalling syntax for selecting the post-processing filter of a NN-based codec, where the filter is selected by a combination of explicit and implicit signals. Different filter indices can be signalled for luma and chroma components and there is a separate signal to turn on or off the processing of each component. The on/off signals (activation/deactivation signals) for each component may be sent first, which allows memory and GPU usage to be optimised in the decoder. In addition, the syntax assigns shorter codes to the most commonly used filters in the shortList and the decoder has a list of commonly used filters for each compression level setting (i.e. quality point). The commonly used filters can be signalled with a shorter message and separate flag (signals) indicate if short or long filter index messages are sent. Furthermore, there is a provided a single flag for the length of all filter index messages and if separate filter indices are signalled for luma and chroma component, they are either all short codes, or all long codes.

### Loss Function

The loss function may include a plurality of items. For an image encoding task, loss items related to reconstruction quality generally include a L1 loss, a L2 loss (or referred to as an MSE loss), an MS-SSIM loss, a VGG loss, an LPIPS loss, a GAN loss, and the like, and further include loss items related to bitstream size.

The L1 loss calculates an average value of errors between points to obtain a L1 loss value. The L1 loss function can better evaluate reconstruction quality of a structured region in an image.

Mean squared error (mean squared error, MSE) loss: a function for measuring a distance between two pieces of data. In this embodiment of this application, the MSE loss is also referred to as the L2 loss function. An average value of squares of errors between points is calculated to obtain an L2 loss value. The MSE loss may also be used to calculate a PSNR. The L2 loss is also a pixel-level loss. The L2 loss function can also better evaluate reconstruction quality of a structured region in an image. If the L2 loss function is used to optimize an image encoding and decoding network, an optimized image encoding and decoding network can achieve a higher PSNR.

Structural similarity index measure (structural similarity index measure, SSIM): an objective criterion for evaluating image quality. Higher SSIM indicates better image quality. In this embodiment of this application, structural similarity between two images at a scale is calculated to obtain an SSIM loss value. The SSIM loss is a loss based on an artificial feature. Compared with the L1 loss function and the L2 loss function, the SSIM loss function can more objectively evaluate image reconstruction quality, that is, evaluate a structured region and an unstructured region of an image in a more balanced manner. If the SSIM loss function is used to optimize an image encoding and decoding network, an optimized image encoding and decoding network can achieve a higher SSIM.

Multi-scale structural similarity index measure (multi-scale SSIM, MS-SSIM): an objective criterion for evaluating image quality. Higher SSIM indicates better image quality. Multi-layer low-pass filtering and downsampling are separately performed on two images to obtain image pairs at a plurality of scales. A contrast map and structure information are extracted from an image pair at each scale, and SSIM loss values at the corresponding scale are obtained based on the contrast map and the structure information. Luminance information of an image pair at a smallest scale is extracted, and a luminance loss value at the smallest scale is obtained based on the luminance information. Then, the SSIM loss values and the luminance loss value at the plurality of scales are aggregated in a manner to obtain an MS-SSIM loss value, for example, an aggregation manner in Equation (1):

$$MS - SSIM ( x , y ) = {[ {l}_{M} ( x , y ) ]}^{{α}_{M} ⋆} {{\prod }^{M}}_{j = 1} {[ {c}_{j} ( x , y ) ]}^{{β}_{j}} {[ {s}_{j} ( x , y ) ]}^{{r}_{j}} \qquad ( 1 )$$

In Equation (1), the loss values at all the scales are aggregated in a manner of exponential power weighting and multiplication. Herein, x and y separately indicate the two images, 1 indicates the loss value based on the luminance information, c indicates the loss value based on the contrast map, and s indicates the loss value based on the structure information. A subscript j=1, . . . , M indicates M scales that separately correspond to total M times of downsampling, j=1 indicates a largest scale, and j=M indicates the smallest scale. The superscripts α, β, and γ each indicate an exponential power of a corresponding term.

The MS-SSIM loss function and the SSIM loss function have similar better image evaluation effect. Compared with the L1 loss and the L2 loss, the MS-SSIM loss for optimization can improve subjective experience of human eyes and meet objective evaluation indicators. If the MS-SSIM loss function is used to optimize an image encoding and decoding network, an optimized image encoding and decoding network can achieve a higher MS-SSIM.

Visual geometry group (visual geometry group, VGG) loss: VGG is the name of an organization that designs a CNN network and names it VGG network. An image loss value determined based on a VGG network is referred to as a VGG loss value. A process of determining a VGG loss value is substantially as follows: A feature of an original image before compression and a feature of a decompressed reconstructed image at a scale (for example, a feature map obtained through convolution calculation at a layer) are separately extracted by using a VGG network, and then a distance between the feature of the original image and the feature of the reconstructed image at this scale is calculated to obtain the VGG loss value. This process is considered as a process of determining a VGG loss value according to a VGG loss function. The VGG loss function focuses on improving reconstruction quality of texture.

Learned perceptual image patch similarity (learned perceptual image patch similarity, LPIPS) loss: an enhanced VGG loss. A multi-scale characteristic is introduced into a process of determining an LPIPS loss value. The process of determining an LPIPS loss value is substantially as follows: Features of the two images at a plurality of scales are separately extracted by using a VGG network, then a distance between the features of the two images at each scale is calculated to obtain a plurality of VGG loss values, and then weighted summation is performed on the plurality of VGG loss values to obtain the LPIPS loss value. This process is considered as a process of determining an LPIPS loss value according to an LPIPS loss function. Similar to the VGG loss function, the LPIPS loss function also focuses on improving reconstruction quality of texture.

Generative adversarial network loss: Features of two images are separately extracted by using a discriminator (also referred to as a discriminator) included in a GAN, and a distance between the features of the two images is calculated to obtain a generative adversarial network loss value. This process is considered as a process of determining a GAN loss value according to a GAN loss function. The GAN loss function also focuses on improving reconstruction quality of texture. The GAN loss includes at least one of a standard GAN loss, a relative GAN loss, a relative average GAN loss, a least squares GAN loss, and the like.

Perceptual loss: a perceptual loss in a broad sense and a perceptual loss in a narrow sense. In this embodiment of this application, the perceptual loss in a narrow sense is used as an example for description. The VGG loss and the LPIPS loss may be considered as a perceptual loss in a narrow sense. However, in another embodiment, a loss calculated based on a depth feature extracted from an image may be considered as a perceptual loss in a broad sense. The perceptual loss in a broad sense may include the perceptual loss in a narrow sense, and may further include a loss, for example, the foregoing GAN loss. The perceptual loss function makes the reconstructed image better satisfy subjective experience of human eyes, but may decrease the PSNR and the MS-SSIM.

### Functional Modules

### Variable Bitrate Module

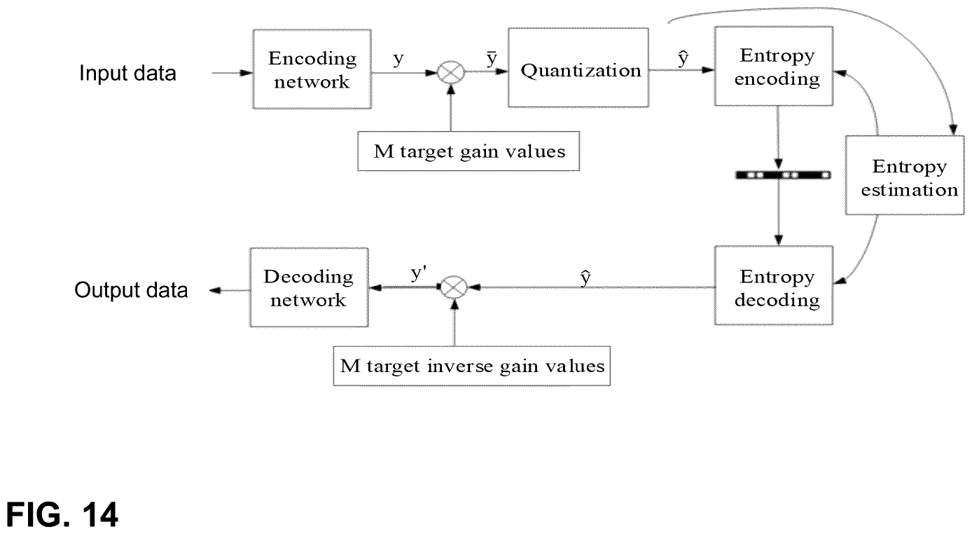

An encoder can output bitstreams at different bit rates. Therefore, in some methods, an output of an encoding network is scaled (for example, each channel is multiplied by a corresponding scaling factor that is also referred to as a target gain value), and an input of a decoding network is inversely scaled (for example, each channel is multiplied by a corresponding scaling factor reciprocal that is also referred to as a target inverse gain value), as shown in FIG. 14. The scaling factor may be preset. Different quality levels or quantization parameters correspond to different target gain values. If the output of the encoding network is scaled to a smaller value, a bitstream size may be decreased. Otherwise, the bitstream size may be increased.

### Colour Format Transform

RGB and YUV are common colour spaces. Conversion between RGB and YUV may be performed according to an equation specified in standards such as CCIR 601 and BT.709.

### Separate Structure for Luma and Chroma

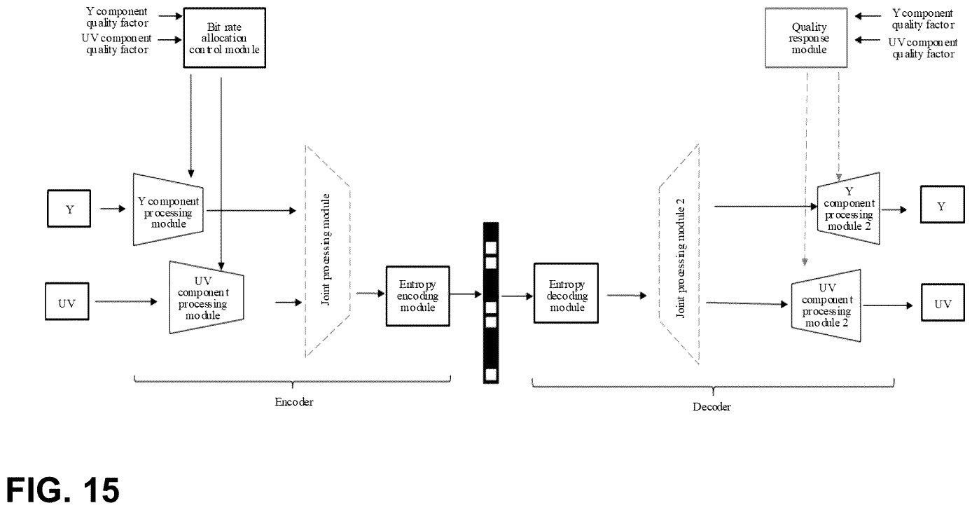

Some VAE-based codecs use the YUV colour space as an input of an encoder and an output of a decoder, as shown in FIG. 15. A Y component indicates luma, and a UV component indicates chroma. Resolution of the UV component may be the same as or lower than that of the Y component. Typical formats include YUV4:4:4, YUV4:2:2, and YUV4:2:0. The Y component is converted into a feature map F_Y through a network, and an entropy encoding module generates a bitstream of the Y component based on the feature map F_Y. The UV component is converted into a feature map F_UV through another network, and the entropy encoding module generates a bitstream of the UV component based on the feature map F_UV. Under this structure, the feature map of the Y component and the feature map of the UV component may be independently quantized, so that bits are flexibly allocated for luma and chroma. For example, for a colour-sensitive image, a feature map of a UV component may be less quantized, and a quantity of bitstream bits for a UV component may be increased, to improve reconstruction quality of the UV component and achieve better visual effect.

In some other methods, an encoder concatenates (concatenate) a Y component and a UV component and then sends to a UV component processing module (for converting image information into a feature map). In addition, a decoder concatenates a reconstructed feature map of the Y component and a reconstructed feature map of the UV component and then sends to a UV component processing module 2 (for converting a feature map into image information). In this method, a correlation between the Y component and the UV component may be used to reduce a bitstream of the UV component.

### Some Exemplary Implementations in Hardware and Software

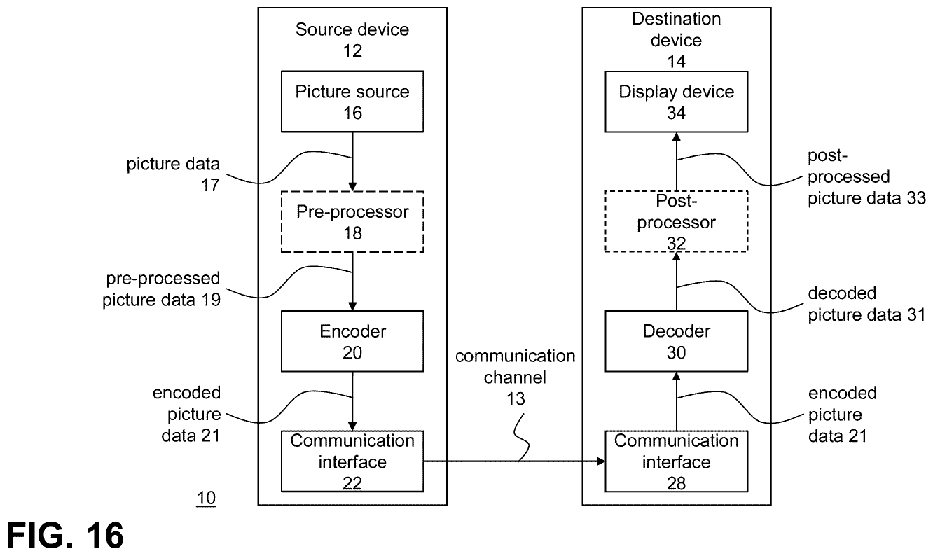

The corresponding system which may deploy the above-mentioned encoder-decoder processing chain is illustrated in FIG. 16. FIG. 16 is a schematic block diagram illustrating an example coding system, e.g. a video, image, audio, and/or other coding system (or short coding system) that may utilize techniques of this present application. Video encoder 20 (or short encoder 20) and video decoder 30 (or short decoder 30) of video coding system 10 represent examples of devices that may be configured to perform techniques in accordance with various examples described in the present application. For example, the video coding and decoding may employ neural network such which may be distributed and which may apply the above-mentioned bitstream parsing and/or bitstream generation to convey feature maps between the distributed computation nodes (two or more).

As shown in FIG. 16, the coding system 10 comprises a source device 12 configured to provide encoded picture data 21 e.g. to a destination device 14 for decoding the encoded picture data 13.

The source device 12 comprises an encoder 20, and may additionally, i.e. optionally, comprise a picture source 16, a pre-processor (or pre-processing unit) 18, e.g. a picture pre-processor 18, and a communication interface or communication unit 22.

The picture source 16 may comprise or be any kind of picture capturing device, for example a camera for capturing a real-world picture, and/or any kind of a picture generating device, for example a computer-graphics processor for generating a computer animated picture, or any kind of other device for obtaining and/or providing a real-world picture, a computer generated picture (e.g. a screen content, a virtual reality (VR) picture) and/or any combination thereof (e.g. an augmented reality (AR) picture). The picture source may be any kind of memory or storage storing any of the aforementioned pictures.

In distinction to the pre-processor 18 and the processing performed by the pre-processing unit 18, the picture or picture data 17 may also be referred to as raw picture or raw picture data 17.

Pre-processor 18 is configured to receive the (raw) picture data 17 and to perform pre-processing on the picture data 17 to obtain a pre-processed picture 19 or pre-processed picture data 19. Pre-processing performed by the pre-processor 18 may, e.g., comprise trimming, color format conversion (e.g. from RGB to YCbCr), color correction, or de-noising. It can be understood that the pre-processing unit 18 may be optional component. It is noted that the pre-processing may also employ a neural network (such as in any of FIGS. 1 to 6) which uses the presence indicator signaling.

The video encoder 20 is configured to receive the pre-processed picture data 19 and provide encoded picture data 21.

Communication interface 22 of the source device 12 may be configured to receive the encoded picture data 21 and to transmit the encoded picture data 21 (or any further processed version thereof) over communication channel 13 to another device, e.g. the destination device 14 or any other device, for storage or direct reconstruction.

The destination device 14 comprises a decoder 30 (e.g. a video decoder 30), and may additionally, i.e. optionally, comprise a communication interface or communication unit 28, a post-processor 32 (or post-processing unit 32) and a display device 34.

The communication interface 28 of the destination device 14 is configured receive the encoded picture data 21 (or any further processed version thereof), e.g. directly from the source device 12 or from any other source, e.g. a storage device, e.g. an encoded picture data storage device, and provide the encoded picture data 21 to the decoder 30.

The communication interface 22 and the communication interface 28 may be configured to transmit or receive the encoded picture data 21 or encoded data 13 via a direct communication link between the source device 12 and the destination device 14, e.g. a direct wired or wireless connection, or via any kind of network, e.g. a wired or wireless network or any combination thereof, or any kind of private and public network, or any kind of combination thereof.

The communication interface 22 may be, e.g., configured to package the encoded picture data 21 into an appropriate format, e.g. packets, and/or process the encoded picture data using any kind of transmission encoding or processing for transmission over a communication link or communication network.

The communication interface 28, forming the counterpart of the communication interface 22, may be, e.g., configured to receive the transmitted data and process the transmission data using any kind of corresponding transmission decoding or processing and/or de-packaging to obtain the encoded picture data 21.

Both, communication interface 22 and communication interface 28 may be configured as unidirectional communication interfaces as indicated by the arrow for the communication channel 13 in FIG. 16 pointing from the source device 12 to the destination device 14, or bi-directional communication interfaces, and may be configured, e.g. to send and receive messages, e.g. to set up a connection, to acknowledge and exchange any other information related to the communication link and/or data transmission, e.g. encoded picture data transmission. The decoder 30 is configured to receive the encoded picture data 21 and provide decoded picture data 31 or a decoded picture 31.

The post-processor 32 of destination device 14 is configured to post-process the decoded picture data 31 (also called reconstructed picture data), e.g. the decoded picture 31, to obtain post-processed picture data 33, e.g. a post-processed picture 33. The post-processing performed by the post-processing unit 32 may comprise, e.g. color format conversion (e.g. from YCbCr to RGB), color correction, trimming, or re-sampling, or any other processing, e.g. for preparing the decoded picture data 31 for display, e.g. by display device 34.

The display device 34 of the destination device 14 is configured to receive the post-processed picture data 33 for displaying the picture, e.g. to a user or viewer. The display device 34 may be or comprise any kind of display for representing the reconstructed picture, e.g. an integrated or external display or monitor. The displays may, e.g. comprise liquid crystal displays (LCD), organic light emitting diodes (OLED) displays, plasma displays, projectors, micro LED displays, liquid crystal on silicon (LCoS), digital light processor (DLP) or any kind of other display.

Although FIG. 16 depicts the source device 12 and the destination device 14 as separate devices, embodiments of devices may also comprise both or both functionalities, the source device 12 or corresponding functionality and the destination device 14 or corresponding functionality. In such embodiments the source device 12 or corresponding functionality and the destination device 14 or corresponding functionality may be implemented using the same hardware and/or software or by separate hardware and/or software or any combination thereof.

As will be apparent for the skilled person based on the description, the existence and (exact) split of functionalities of the different units or functionalities within the source device 12 and/or destination device 14 as shown in FIG. 16 may vary depending on the actual device and application.

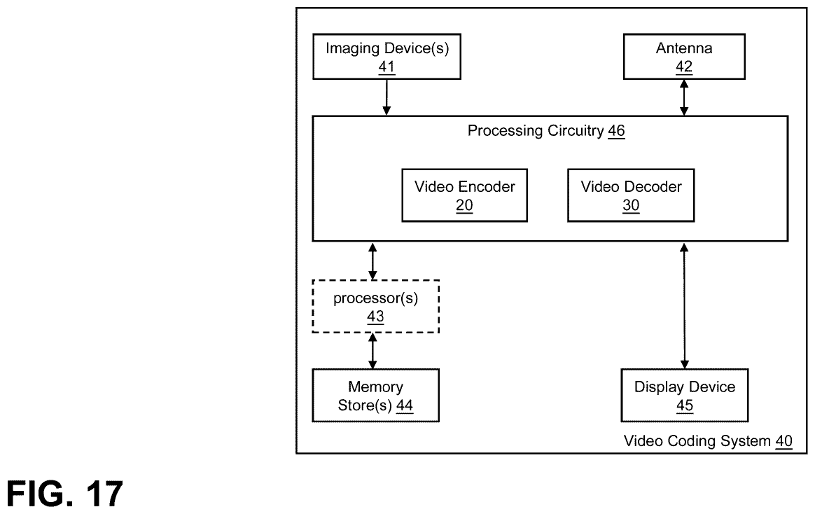

The encoder 20 (e.g. a video encoder 20) or the decoder 30 (e.g. a video decoder 30) or both encoder 20 and decoder 30 may be implemented via processing circuitry, such as one or more microprocessors, digital signal processors (DSPs), application-specific integrated circuits (ASICs), field-programmable gate arrays (FPGAs), discrete logic, hardware, video coding dedicated or any combinations thereof. The encoder 20 may be implemented via processing circuitry 46 to embody the various modules including the neural network or its parts. The decoder 30 may be implemented via processing circuitry 46 to embody any coding system or subsystem described herein. The processing circuitry may be configured to perform the various operations as discussed later. If the techniques are implemented partially in software, a device may store instructions for the software in a suitable, non-transitory computer-readable storage medium and may execute the instructions in hardware using one or more processors to perform the techniques of this disclosure. Either of video encoder 20 and video decoder 30 may be integrated as part of a combined encoder/decoder (CODEC) in a single device, for example, as shown in FIG. 17.

Source device 12 and destination device 14 may comprise any of a wide range of devices, including any kind of handheld or stationary devices, e.g. notebook or laptop computers, mobile phones, smart phones, tablets or tablet computers, cameras, desktop computers, set-top boxes, televisions, display devices, digital media players, video gaming consoles, video streaming devices (such as content services servers or content delivery servers), broadcast receiver device, broadcast transmitter device, or the like and may use no or any kind of operating system. In some cases, the source device 12 and the destination device 14 may be equipped for wireless communication. Thus, the source device 12 and the destination device 14 may be wireless communication devices.

In some cases, video coding system 10 illustrated in FIG. 16 is merely an example and the techniques of the present application may apply to video coding settings (e.g., video encoding or video decoding) that do not necessarily include any data communication between the encoding and decoding devices. In other examples, data is retrieved from a local memory, streamed over a network, or the like. A video encoding device may encode and store data to memory, and/or a video decoding device may retrieve and decode data from memory. In some examples, the encoding and decoding is performed by devices that do not communicate with one another, but simply encode data to memory and/or retrieve and decode data from memory.

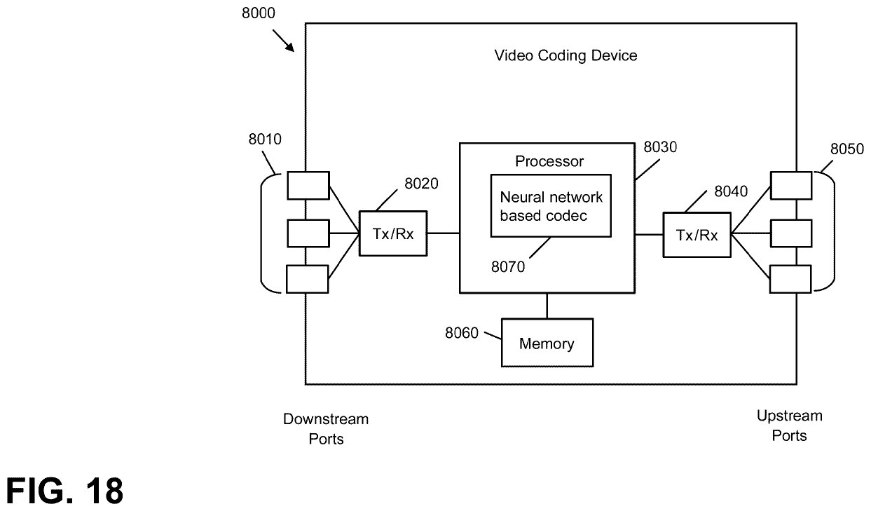

FIG. 18 is a schematic diagram of a video coding device 8000 according to an embodiment of the disclosure. The video coding device 8000 is suitable for implementing the disclosed embodiments as described herein. In an embodiment, the video coding device 8000 may be a decoder such as video decoder 30 of FIG. 16 or an encoder such as video encoder 20 of FIG. 16.

The video coding device 8000 comprises ingress ports 8010 (or input ports 8010) and receiver units (Rx) 8020 for receiving data; a processor, logic unit, or central processing unit (CPU) 8030 to process the data; transmitter units (Tx) 8040 and egress ports 8050 (or output ports 8050) for transmitting the data; and a memory 8060 for storing the data. The video coding device 8000 may also comprise optical-to-electrical (OE) components and electrical-to-optical (EO) components coupled to the ingress ports 8010, the receiver units 8020, the transmitter units 8040, and the egress ports 8050 for egress or ingress of optical or electrical signals.

The processor 8030 is implemented by hardware and software. The processor 8030 may be implemented as one or more CPU chips, cores (e.g., as a multi-core processor), FPGAs, ASICs, and DSPs. The processor 8030 is in communication with the ingress ports 8010, receiver units 8020, transmitter units 8040, egress ports 8050, and memory 8060. The processor 8030 comprises a neural network based codec 8070. The neural network based codec 8070 implements the disclosed embodiments described above. For instance, the neural network based codec 8070 implements, processes, prepares, or provides the various coding operations. The inclusion of the neural network based codec 8070 therefore provides a substantial improvement to the functionality of the video coding device 8000 and effects a transformation of the video coding device 8000 to a different state. Alternatively, the neural network based codec 8070 is implemented as instructions stored in the memory 8060 and executed by the processor 8030.

The memory 8060 may comprise one or more disks, tape drives, and solid-state drives and may be used as an over-flow data storage device, to store programs when such programs are selected for execution, and to store instructions and data that are read during program execution. The memory 8060 may be, for example, volatile and/or non-volatile and may be a read-only memory (ROM), random access memory (RAM), ternary content-addressable memory (TCAM), and/or static random-access memory (SRAM).

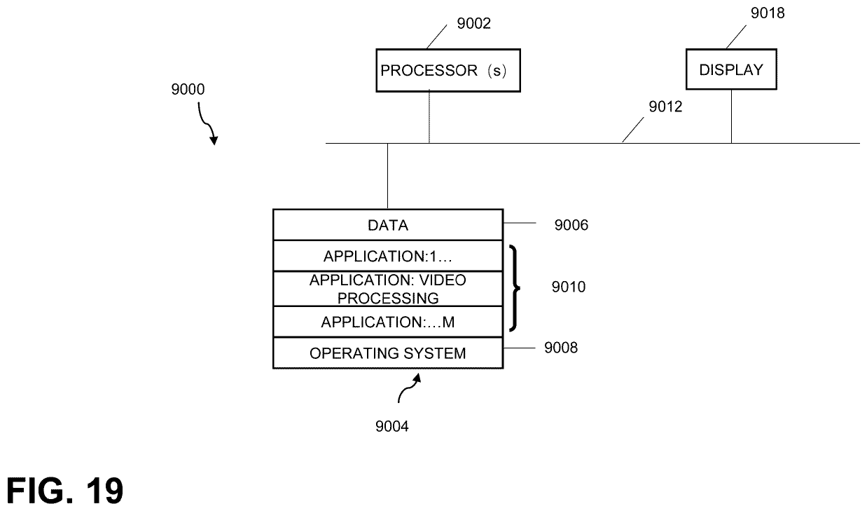

FIG. 19 is a simplified block diagram of an apparatus that may be used as either or both of the source device 12 and the destination device 14 from FIG. 16 according to an exemplary embodiment.

A processor 9002 in the apparatus 9000 can be a central processing unit. Alternatively, the processor 9002 can be any other type of device, or multiple devices, capable of manipulating or processing information now-existing or hereafter developed. Although the disclosed implementations can be practiced with a single processor as shown, e.g., the processor 9002, advantages in speed and efficiency can be achieved using more than one processor.

A memory 9004 in the apparatus 9000 can be a read only memory (ROM) device or a random access memory (RAM) device in an implementation. Any other suitable type of storage device can be used as the memory 9004. The memory 9004 can include code and data 9006 that is accessed by the processor 9002 using a bus 9012. The memory 9004 can further include an operating system 9008 and application programs 9010, the application programs 9010 including at least one program that permits the processor 9002 to perform the methods described here. For example, the application programs 9010 can include applications 1 through N, which further include a video coding application that performs the methods described here.

The apparatus 9000 can also include one or more output devices, such as a display 9018. The display 9018 may be, in one example, a touch sensitive display that combines a display with a touch sensitive element that is operable to sense touch inputs. The display 9018 can be coupled to the processor 9002 via the bus 9012.

Although depicted here as a single bus, the bus 9012 of the apparatus 9000 can be composed of multiple buses. Further, a secondary storage can be directly coupled to the other components of the apparatus 9000 or can be accessed via a network and can comprise a single integrated unit such as a memory card or multiple units such as multiple memory cards. The apparatus 9000 can thus be implemented in a wide variety of configurations.

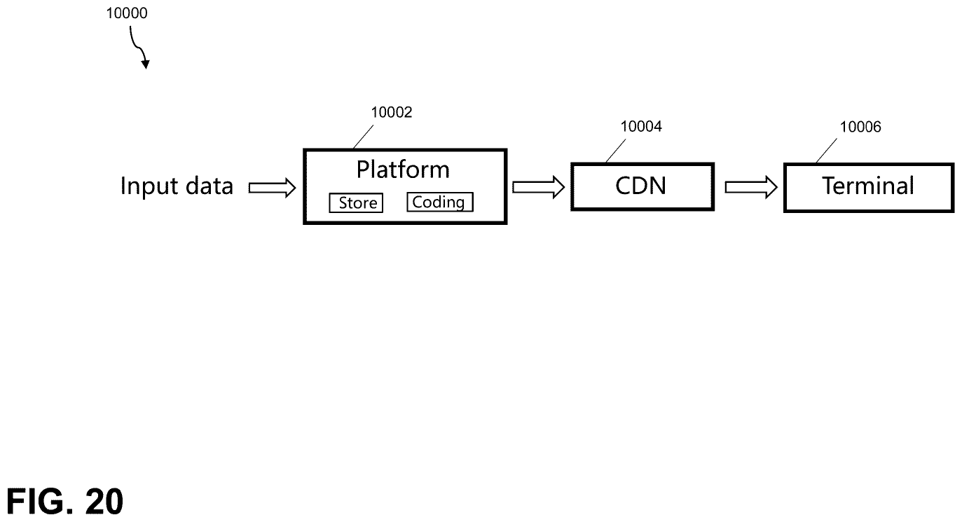

FIG. 20 is a block diagram of a video coding system 10000 according to an embodiment of the disclosure.

A platform 10002 in the system 10000 can be Software as a Service (SaaS), Platform as a Service (PaaS), Infrastructure as a Service (IaaS) etc. or a local service. Alternatively, the platform 10002 can be any other type of device, or multiple devices, capable of calculation, storing, transcoding, encryption, rendering, decoding or encoding. Although the disclosed implementations can be practiced with a single platform as shown, e.g., the platform 10002, advantages in speed and efficiency can be achieved using more than one platform.

A content delivery network (CDN) 10004 in the system 10000 can be a group of geographically distributed servers. Alternatively, the CDN 10004 can be any other type of device, or multiple devices, capable of data buffering, scheduling, dissemination or speed up the delivery of web content by bringing it closer to where users are. Although the disclosed implementations can be practiced with a single CDN as shown, e.g., the CDN 10004, advantages in speed and efficiency can be achieved using more than one CDN.

A terminal 10006 in the apparatus 10000 can be a mobile phone, computer, television, laptop, camera. Alternatively, the terminal 10006 can be any other type of device, or multiple devices, capable of displaying video or image.

1. A method for decoding for a codec, the method comprising:
receiving a bitstream comprising an image to be decoded;
determining one or more neural network-based encoder model parameters based on a codec index that identifies the codec;
determining a plurality of filter lists based on the one or more neural network-based encoder model parameters, the plurality of filter lists comprising a short list and a long list of luma filters, and a short list and a long list of chroma filters;
receiving a plurality of signals comprising:
filter index information comprising a luma filter index and a chroma filter index,
filter list information comprising an indication of a length of a luma filter list to be used and an indication of a length of a chroma filter list to be used, and
filter selection information for determining a luma filter and a chroma filter to be used to decode the image;
selecting, based on the determined one or more neural network based encoder model parameters, the determined filter lists and the received plurality of signals, a luma filter list and/or a chroma filter list for processing the image, wherein:
the selected luma filter list is a short list of luma filters or a long list of luma filters, and/or
the selected chroma filter list is a short list of chroma filters or a long list of chroma filters; and
processing the image using a luma filter from the selected luma filter list and/or a chroma filter from the selected chroma filter list.

2. The method according to claim 1, wherein selecting the luma filter list and/or selecting the chroma filter list is based on the filter list information.

3. The method according to claim 1, wherein the short list of luma filters is comprised of two or more luma filters of the luma filter index that are the most frequently applied for the codec; and
the short list of chroma filters is comprised of two or more of chroma filters from the chroma filter index that are the most frequently applied for the codec.

4. The method according to claim 1, wherein the short list of luma filters and the short list of chroma filters are each represented by at least 1 bit, and wherein the long list of luma filters and the long list of chroma filters are each represented by at least 3 bits.

5. The method according to claim 1, the method further comprising;
determining a quality loss for the image in the bitstream compared to the original image;
determining a quality loss for the image processed by each luma filter and/or a chroma filter used by the luma filter model and/or a chroma filter model by comparing each luma filter and/or a chroma filter used by the luma filter model and/or a chroma filter model to the original image; and
selecting whether to use the image in the bitstream or the image processed by the luma and/or chroma filter based on the determined quality loss of each luma filter and/or a chroma filter used by the luma filter model and/or a chroma filter model selected from the filter selection information and the quality loss for the image in the bitstream compared to the original image.

6. The method according to claim 1, wherein the filter selection information comprises binary information indicating whether each luma or chroma filter separately and distinctly are activated.

7. The method according to claim 6, wherein one or more of the luma and/or chroma filters are not activated, and the filter used for processing the image is the luma and/or chroma filter from the received filter index information.

8. The method according to claim 4, wherein the long list of luma filters and the long list of chroma filters are each represented by at least 3 bits, the long list of luma filters comprises the filters from the luma filter index that are not comprised in the short list of luma filters, and the long list of chroma filters comprises the filters from the chroma filter index that are not comprised in the short list of chroma filters; or
the long list of luma filters and the long list of chroma filters are each represented by at least 4 bits, the long list of luma filters comprises all of the filters from the luma filter index, and the long list of chroma filters comprises all of the filters from the chroma filter index.

9. The method according to claim 1, wherein the filter list information indicates that a length of the luma filter list to be used is short and the short list of luma filters is indicated as true, and a length of the chroma filter list to be used is short and the short list of chroma filters is indicated as true.

10. The method according to claim 1, wherein the filter selection information for determining a luma filter and a chroma filter to be used to decode the image indicates that both the luma filter and the chroma filter are false, and no filter is applied to the image in the bitstream.

11. An apparatus for decoding, comprising:
processing circuitry configured to:
receive a bitstream comprising an image to be decoded;
determine one or more neural network-based encoder model parameters based on a codec index that identifies the codec;
determine a plurality of filter lists based on the one or more neural network-based encoder model parameters, the plurality of filter lists comprising a short list and a long list of luma filters and a short list and a long list of chroma filters;
receive a plurality of signals comprising:
filter index information comprising a luma filter index and a chroma filter index,
filter list information comprising an indication of a length of a luma filter list to be used and an indication of a length of a chroma filter list to be used, and
filter selection information for determining a luma filter and a chroma filter to be used to decode the image;
select, based on the determined one or more neural network based encoder model parameters, the determined filter lists and the received plurality of signals, a luma filter list and/or a chroma filter list for processing the image, wherein:
the selected luma filter list is a short list of luma filters or a long list of luma filters, and/or
the selected chroma filter list is a short list of chroma filters or a long list of chroma filters; and
process the image using a luma filter from the selected luma filter list and/or a chroma filter from the selected chroma filter list.

12. The apparatus for decoding according to claim 11, wherein selecting the luma filter list and/or selecting the chroma filter list is based on the filter list information.

13. The apparatus for decoding according to claim 11, wherein the short list of luma filters is comprised of two or more luma filters of the luma filter index that are the most frequently applied for the codec; and
the short list of chroma filters is comprised of two or more of chroma filters from the chroma filter index that are the most frequently applied for the codec.

14. The apparatus for decoding according to claim 11, wherein the short list of luma filters and the short list of chroma filters are each represented by at least 1 bit, and wherein the long list of luma filters and the long list of chroma filters are each represented by at least 3 bits.

15. The apparatus for decoding according to claim 11, the one or more processing units further configured to:
select whether to use the processed image or the image in the bitstream prior to processing based on the filter selection information.

16. The apparatus for decoding according to claim 11, wherein the filter selection information comprises binary information indicating whether each luma or chroma filter separately and distinctly are activated.

17. The apparatus for decoding according to claim 16, wherein one or more of the luma and/or chroma filters are not activated, and the filter used for processing the image is the luma and/or chroma filter from the received filter index information.

18. The apparatus for decoding according to claim 14, wherein the long list of luma filters and the long list of chroma filters are each represented by at least 3 bits, the long list of luma filters comprises the filters from the luma filter index that are not comprised in the short list of luma filters, and the long list of chroma filters comprises the filters from the chroma filter index that are not comprised in the short list of chroma filters; or
the long list of luma filters and the long list of chroma filters are each represented by at least 4 bits, the long list of luma filters comprises all of the filters from the luma filter index, and the long list of chroma filters comprises all of the filters from the chroma filter index.

19. The apparatus for decoding according to claim 11, wherein the filter list information indicates that a length of the luma filter list to be used is short and the short list of luma filters is indicated as true, and a length of the chroma filter list to be used is short and the short list of chroma filters is indicated as true.

20. The apparatus for decoding according to claim 11, wherein the filter selection information for determining a luma filter and a chroma filter to be used to decode the image indicates that both the luma filter and the chroma filter are false, and no filter is applied to the image in the bitstream.
